(19) United States
(12) Patent Application Publication
(10) Pub. No.: US 2023/0289846 A1
(43) Pub. Date: Sep. 14, 2023

(54) WALLET STEERING: SYSTEM, ENGINE, METHOD, AND PROFESSIONAL SERVICES TO PROGRAMMATICALLY, PRECISELY, AND PROFITABLY STEER CONSUMER PURCHASES FROM ONE BUSINESS TO ANOTHER AND/OR ONE PRODUCT/SERVICE TO ANOTHER

(71) Applicants: Gunter Pfau, Philadelphia, PA (US); Aaron McLean, Chestertown, MD (US); Scott Wasserman, Haddonfield, NJ (US); Jakov Suran, Pula (HR)

(72) Inventors: Gunter Pfau, Philadelphia, PA (US); Aaron McLean, Chestertown, MD (US); Scott Wasserman, Haddonfield, NJ (US); Jakov Suran, Pula (HR)

(21) Appl. No.: 18/174,434

(22) Filed: Feb. 24, 2023

Related U.S. Application Data
(60) Provisional application No. 63/313,354, filed on Feb. 24, 2022.

(51) Int. Cl. G06Q 30/0207; G06Q 30/0203; G06Q 30/0238

(52) U.S. Cl. CPC G06Q 30/0224; G06Q 30/0203; G06Q 30/0238

(57) ABSTRACT

Systems and methods for wallet steering are disclosed. A wallet steering method in accordance with the present disclosure may comprise receiving a consumer identifier, such as a phone number, during a transaction. In response to receiving the consumer identifier, a consumer member profile is automatically created for the consumer identifier and data elements associated with the transaction and/or consumer are be stored in the consumer member profile. The consumer member profile may be built over time based on transactions associated with the consumer identifier. Customized offers which precisely and profitably steer consumer purchases from one business to another, one product/service to another and/or one payment tender to another may then be generated based on the consumer profile.

### CROSS-REFERENCE TO RELATED APPLICATION

This application claims the benefit of priority to U.S. Provisional Patent Application Ser. No. 63/313,354, filed Feb. 24, 2022, entitled “WALLET STEERING: SYSTEM, ENGINE, METHOD, AND PROFESSIONAL SERVICES TO PROGRAMMATICALLY, PRECISELY, AND PROFITABLY STEER CONSUMER PURCHASES FROM ONE BUSINESS TO ANOTHER AND/OR ONE PRODUCT/SERVICE TO ANOTHER,” the entire contents and disclosure of which is hereby incorporated by reference in its entirety.

### FIELD OF THE INVENTION

The present invention relates to the use of a system for Wallet Steering automation, and, more particularly, to an engine, method, and professional services used for providing software applications, analytic services, and solutions to acquire consumer product and service purchasing data and behavior for physical merchants, consumer packaged goods manufacturers, online merchants, and financial services companies, and doing so across diverse operating platforms.

### BACKGROUND

There are billions of consumer purchases/transactions taking place across many different types of businesses, including physical merchants operating traditional brick and mortar retail stores, consumer packaged goods manufacturers, providers of hospitality services, providers of food services, providers of entertainment services, and online merchants on a monthly basis. For the sake of clarity, these consumer purchases/transactions include manufactured goods (including but not limited to items such as ready-made foods, snacks, tobacco, fuel, clothing, makeup, jewelry, sporting goods, consumer electronics, automotive parts, and all other manufactured products) and services-for-hire (including but not limited to items such as hotel room accommodations, airline, rail/train, bus, taxi, or other transportation-for-hire services, automotive maintenance and repair services, healthcare services, dry cleaning services, landscaping services, housekeeping services, entertainment services such as musical concerts, movies, live performances, and the like, and all other services-for-purchase that are typical and routine for consumers). There are many categories of businesses that would benefit from having an understanding of consumer purchasing data and being able to steer consumer purchasing behavior to their business by using their understanding of consumer purchasing data intelligently and programmatically at scale. For illustrative purposes, we are providing a few example categories of businesses hereafter. While the illustrations are specific, Wallet Steering applies to any business which seeks to steer a greater share of purchases that consumers are making with competitors to their business. Example categories of businesses for which Wallet Steering is applicable include (A) merchants which are retailers of goods and services which operate either or both physical brick-and-mortar retail stores and online marketplaces (i.e., e-commerce stores). Examples of these are convenience and fuel retailers, grocery stores, fashion/clothing stores, auto parts and services stores, dollar store operators, big box store operators food retailers including the likes of quick service restaurants, entertainment venues, etc., airline operators, hotel operators, resort operators, travel booking operators, and many more; (B) consumer packaged goods manufacturers, which are the manufacturing businesses that supply products for merchants to sell to consumers and in some instances, which sell their products to consumers directly, such as pre-packaged foods manufacturers, clothing manufacturers, auto parts manufacturers, tobacco product marketers and brands, beverage manufacturers and brands, consumer electronics manufacturers, furniture manufacturers, and many more; and (C) financial services companies, such as credit card issuing banks, payment processors, and many other types of companies that provide financial technologies and services to consumers, merchants, and manufacturers. To illustrate the incredible visit, purchase/transaction, and data volume, let's take a look at the figures for just one of the many brick-and-mortar retail verticals; according to the National Association for Convenience Stores, the average convenience and fuel retail store selling fuel has around 1,100 consumers per day, or more than 400,000 per year. Cumulatively, the U.S. convenience store industry, made up of approximately 150,000 individual retail sites, alone serves 160 million consumers per day generating hundreds of millions of purchases/transactions per month. A convenience and fuel retail business operator, like other businesses outlined above, has a specific need which, prior to Stuzo's creation of Wallet Steering, had no automated, scalable, programmatic, turnkey solution for. To illustrate the nature of this need, imagine that a convenience and fuel retail store operator has a consumer named Sally. Sally visits one of their stores routinely. Of the many different products sold/offered by the convenience and fuel retail store operator (typically around 2,500 different SKUs), when Sally visits, she typically only purchases a few different SKUs, such as a favorite candy bar, a favorite bottled beverage, and regular grade fuel. However this same consumer, Sally, also shops on other days at a grocery store nearby. When at that grocery store, Sally is purchasing those same products—the same favorite candy bar and the same favorite bottled beverage—and she also fills up her car's tank with fuel offered at a competitive gas station. In this scenario, which is very typical across millions of consumers, the convenience and fuel retail store operator would want to know that Sally is buying products from the competitive gas station down the street that she could be buying from them. Having this knowledge would then enable the convenience and fuel retail store operator to try to get Sally to buy more of those same products from their location, instead of from the competition. Therefore, a particular business needs a turnkey solution which provides them (A) the ability to programmatically link one specific product or service, or a group of related products or services that a particular business is selling to specific transactions and/or purchase activities of particular individual consumers in an architecture and data model where this link and the connected data (“Wallet(s)”) can be leveraged to execute Wallet Steering, (B) the ability to programmatically and automatically understand the total quantity of one specific product or service, or a group of related products or services (sold by a particular business) that a specific consumer purchases in a day, week, month, or other specific time period from that business and from across other competitive businesses that the consumer buys said product(s) or service(s) from (“Wallet Capacity”), (C) the ability to programmatically and automatically send a specialized and unique type of survey to a specific consumer to ascertain structured data for the specific consumer's Wallet Capacity purchase behavior across any Wallets (“Wallet Survey”), including the programmatic and automatic incorporation of the structured data survey response information into the technical data model and architecture, making Wallet Capacity available as a targeting attribute for Dynamic Audiences and available for the programmatic calculation of Wallet Opportunity, (D) the ability to programmatically and automatically understand the total quantity of one specific product or service, or a group of related products or services sold by a particular business that a specific consumer purchases from the particular business in a specific time period (“Share of Wallet”), (E) the ability to programmatically and automatically understand the quantity of one specific product or service, or a group of related products or services sold by a particular business that a specific consumer purchases from that particular business's competitors in a specific time period, revealed via Wallet Surveys and other means of acquiring Wallet Capacity data and mathematically calculated using Wallet data which could include one or more of Wallet Capacity, Share of Wallet, or other data, which is incorporated into the technical data model and architecture (“Wallet Opportunity”), and (F) the ability to combine the power of the aforementioned (Wallets, Wallet Capacity, Wallet Surveys, Share of Wallet, and Wallet Opportunity) in real-time, in a proactive and automated fashion—while a specific consumer is standing at a particular business's brick-and-mortar location, while a specific consumer is in transit moving from point A to B, and/or while the consumer is visiting a particular business's website and/or is using a particular business's mobile/digital application—to precisely, programmatically, and profitably incentivize the specific consumer or a group of consumers that are all already purchasing the same product(s) or service(s) from a particular business's competitors, to buy more of those specific products or services from that particular business (“Wallet Steering”).

When a particular business is executing Wallet Steering via a membership-based couponing or promotional campaign, a rewards program, a loyalty program, a digital payments program, an integrated loyalty/rewards and mobile payments program, a membership-plan program, a subscription-based program, a cross-channel consumer communications program, or a hyper-personalized cross-channel consumer experience that integrates into a particular business's enterprise systems or other 3rd party technology enterprise systems, we refer to this as a “Wallet Steering Program.”

Thus, there exists a need for a system, engine, method, and professional services delivered in part or in whole to empower businesses with an easy-to-use, repeatable, predictable, highly valid, precise, and programmatic Wallet Steering solution for the purposeful steering of Wallet Opportunity and Share of Wallet away from one particular business to another, away from one product/service to another, or away from one payment method/tender to another and doing so across diverse operating platforms, physical brick-and-mortar retail stores and online marketplaces (i.e., e-commerce stores). The Wallet Steering invention empowers businesses to gain the greatest possible Share of Wallet from each of their consumers and to significantly increase and maximize the lifetime value of each of their consumers across the multitude of consumer Wallets they can serve, and to do so by taking this Share of Wallet away from their competitors. Addressing a multitude of consumers and Wallets at scale with automation requires a particular business to be able to use Dynamic Audiences, which are one specific consumer or a group of consumers, programmatically and dynamically placed in or removed from—in real-time—a targetable grouping based on known attributes and data, such as (but not limited to) Wallets, Wallet Capacity, Share of Wallet, Wallet Opportunity, a specific consumer's prior purchase behavior, tasks completed by a specific consumer (such as program enrollment, last time a consumer accessed a program, etc.), real-time data about a specific consumer (such as the consumer's location, standing in front of a store, or parking in front of a gas pump, or entering a grocery store, or approaching a car wash, etc.) personal information about a specific consumer (such as their birthdate, zip code of residence, etc.), information about a particular business (such as a grouping of a set of stores in a specific geographic region, hours of operation, etc.), and many more targetable attributes. To bring the aforementioned system to life, imagine you run a busy coffee shop and you want to sell more cups of coffee to the 1,000 or so consumers that come to your shop daily. Without this Wallet Steering invention, you would not be able to understand and dynamically take action to gain a greater Share of Wallet, more coffee purchases, from Mary, who is one of your consumers and who in total buys 6 coffees per week (Mary's Wallet Capacity), some from your business and some from your competitors. With the Wallet Steering invention you understand that, while Mary is buying a total of 6 coffees per week, she is currently only buying 2 of those coffees from your business and therefore, your Wallet Opportunity with Mary's coffee Wallet is 4 coffees per week. The Wallet Steering invention empowers your busy coffee shop to operate a Wallet Steering Program, through which you incentivize Mary to steer more of her coffee Wallet away from your competitors and to your business with Wallet Steering Experiences (different types of digital consumer engagements such as offers, combo deals, buy-[X]-get-[Y]-free, coupons, cents off per gallon, discounts, rewards, sweepstakes, surprise and delight engagements, contests, games, punch cards, and/or marketing communications such as product promotions, store announcements, business announcements, weather announcements, holiday announcements, birthday best wishes, and many others, created by a particular business and sent to one or more specific Dynamic Audiences for the purpose of earning incremental Share of Wallet from consumers in the specific Dynamic Audience, and are also the mechanisms through which Wallet Steering Currencies are exchanged between a specific consumer and a particular business). Wallet Steering Currencies are digital units or increments of stored value a specific consumer may earn from a particular business, held in a specific consumer's secure membership account, which a specific consumer may exchange with a particular business for something of value offered to the consumer by the business. For example, Wallet Steering Currencies may include (but are not limited to) points, cash back for immediate use, cash back for later use, stars, badges, or other representations of units of value. By utilizing Wallet Steering Experiences and Wallet Steering Currencies via operation of your Wallet Steering Program, your busy coffee shop ensures you are specifically steering and are only spending your valuable marketing dollars/spend on net new, incremental purchase behavior from Mary (by only steering her Wallet Opportunity) and thus not spending money to fund Mary's existing purchase behavior (meaning, you are offering Mary a discount or other incentive to buy the 4 coffees that she is buying from your competitors, but you are not offering Mary a discount on the 2 coffees she is already buying from your business). A unique trait of Wallet Steering is that it enables the coffee shop business described above to not only do this with Mary, but to do this with all consumers on a one-to-one basis, providing each consumer with a hyper-personalized Wallet Steering Experience while empowering the business to thrive, relative to competitors. Now, imagine being able to do Wallet Steering in an automated manner for a business that has thousands of brick-and-mortar locations and/or millions of consumers per day, whether shopping at a physical brick-and-mortar retail store or online marketplace. This is the unique and novel capability of the Wallet Steering invention.

### BRIEF SUMMARY

The present Wallet Steering invention includes at least a computer-implemented engine, system, method, and professional services for providing applications, analytic services, consumer surveying (Wallet Surveys), consumer data storage (Wallets, Wallet Capacity, Share of Wallet, Wallet Opportunity, Dynamic Audiences), business data storage, automated data analytics, advanced machine learning rules and rules engine, and solutions to acquire consumer product and services purchasing behavior across diverse operating platforms, online retail commerce locations, and physical retail locations. It is to be understood that both the foregoing general description and the following detailed description are exemplary and explanatory, and are intended to provide further explanation of the invention as discussed herein throughout.

### BRIEF DESCRIPTION OF THE DRAWINGS

The accompanying drawings are included to provide a further understanding of the disclosed embodiments. In the drawings, like numerals represent like elements, and:

FIG. 1 illustrates an exemplary computing system for use in accordance with herein described system and methods of the present invention;

FIG. 2 illustrates an exemplary networked computing environment for use in accordance with herein described system and methods of the present invention;

FIGS. 3A-3D illustrate a flow chart illustrating exemplary steps of Wallet Steering, an embodiment of a method of identifying a consumer, converting them into a Wallet Steering Program member, identifying their purchase behavior, and acquiring more purchase behavior from the consumer;

FIGS. 4A and 4B are an exemplary consumer profiles associated with Wallet Steering;

FIG. 5 is an exemplary Open Commerce Command Center user interface screens from the present invention;

FIG. 6 is an exemplary Open Commerce Command Center user interface screens from the present invention;

FIG. 7 is an exemplary Open Commerce Command Center user interface screens from the present invention;

FIG. 8 is an exemplary Open Commerce Command Center user interface screens from the present invention;

FIG. 9 is an exemplary Open Commerce Command Center user interface screens from the present invention;

FIGS. 10A-10B illustrate an exemplary Open Commerce Command Center user interface screens from the present invention;

FIG. 11 is an exemplary Open Commerce Command Center user interface screens from the present invention;

FIG. 12 is an exemplary Open Commerce Command Center user interface screens from the present invention;

FIG. 13 is an exemplary Open Commerce Command Center user interface screens from the present invention;

FIG. 14 is an exemplary Open Commerce Command Center user interface screens from the present invention;

FIG. 15 is an exemplary Open Commerce Command Center user interface screens from the present invention;

FIG. 16 is an exemplary Open Commerce Command Center user interface screens from the present invention;

FIG. 17 is an exemplary Open Commerce Command Center user interface screens from the present invention;

FIG. 18 is an exemplary Open Commerce Command Center user interface screens from the present invention;

FIG. 19 is an exemplary Open Commerce Command Center user interface screens from the present invention;

FIG. 20 provides descriptions of exemplary services provided by Stuzo to businesses in conjunction with Wallet Steering;

FIG. 21 is an illustrative diagram depicting the multiple methods for acquiring Wallet Capacity data;

FIGS. 22A-22C illustrate a diagram depicting typical consumer purchase behavior as it relates to Wallet Steering, provided for adding clarity and specificity to the present invention;

FIGS. 23A-23B are an extension of the concepts established in FIGS. 22A-22C, providing examples for how businesses in partnership with each other may use the present invention;

FIGS. 24A-24B build upon the concepts established in FIGS. 3A-3D and 21 and illustrate how the present invention may be used by different types of businesses for other novel Wallet Steering purposes;

FIGS. 25A-25B illustrate a variant of FIGS. 24A-24B, building upon the concepts established in FIGS. 24A-24B and illustrate how the present invention may be used by different types of businesses for other novel Wallet Steering purposes;

FIGS. 26A-26C illustrate how a consumer may use different payment methods at different businesses for different types of purchases and how the different businesses may employ other novel Wallet Steering concepts;

FIGS. 27A-27B build upon the concepts established in FIGS. 26A-26C and illustrate another exemplary business to business partnership wherein multiple business parties together use novel Wallet Steering concepts;

FIGS. 28A-28B illustrate corporate-to-franchise business relationships and how these business relationships relate to an exemplary embodiment of the present invention;

FIGS. 29A-29C illustrate a variety of Wallet Steering Experiences which may utilize various Wallet Steering Currencies, representing an exemplary embodiment of the present invention;

FIGS. 30A-30E illustrate how Wallet Steering Program Enrollment and Identification enables a particular business running a Wallet Steering Program to enable consumers to enroll as members in the particular business's program and to self-identify for ongoing participation in the particular business's program via use of different technologies, an exemplary embodiment of the present invention;

### DETAILED DESCRIPTION

Computer-implemented platforms and engines (referred to and illustrated in exemplary Figures attached hereto, as “Open Commerce”), systems, and methods of use are disclosed that provide Wallet Steering Programs and capabilities via networked access to a plurality of types of digital content (including but not limited to video, audio, imagery, text, metadata, interactive and document content) through a plurality of types of digital content delivery channels (SMS and MMS text messages, mobile device push notifications, email communications, websites, native mobile applications, progressive web applications, point of sale system displays, fuel dispenser system displays, point of sale pin pad devices, interactive voice-enabled devices, wearable device applications, kiosk devices, internet enabled vehicle infotainment system applications, television screens, video game consoles or within video games, or other internet connected devices), and through a plurality of types of physical content delivery mediums (such as printed receipts from point of sale systems, printed marketing and advertising materials, direct mail, or other printed materials), and that track, deliver, manipulate, transform and report the accessed content through the aforementioned delivery channels. Described embodiments of these platforms, engines, systems and methods are intended to be exemplary and not limiting. For clarity, Open Commerce is Stuzo's proprietary software product suite built atop a Stuzo technology platform, which Stuzo licenses to its business customers under a Software-as-a-Service (SaaS) license and which Stuzo's customers use for Wallet Steering. As such, it is contemplated that the herein described systems and methods can be adapted to provide many types of marketplaces, consumer loyalty applications, consumer rewards applications, consumer couponing applications, consumer promotional applications, consumer discounting applications, consumer membership-based applications, consumer subscription-based applications, consumer digital payment applications, cross-channel consumer engagement applications, consumer surveying applications, digital currency or points accounting applications, and the like, and can be extended to provide enhancements and/or additions to the exemplary platforms, engines, systems and methods described. The invention is thus intended to include all such extensions.

The present invention provides a cross-channel engagement platform (Open Commerce) to enable Wallet Steering via the operation of Wallet Steering Programs, which may enable the delivery of out-of-the-box app-like experiences and analytics across a wide variety of physical brick-and-mortar retail store or online retailers or marketplace channels as described above herein. The platform may be API (i.e., webservices) driven with pluggable constructs and with connected bidirectional 3rd party technology integrations (i.e., card issuing banks, payment processors, payment security technology providers, point of sale systems, online marketplace software systems, and the like).

Wallet Steering Programs may be built via a set of webservices. Wallet Steering Programs are available to consumers through a wide variety of physical brick-and-mortar retail store, online retailers or marketplace platforms, or digital channels as illustrated above herein.

The platforms and engines may enable non-technical end users of the platform to configure and deploy Wallet Steering Programs and automated or manual marketing campaigns through an administrative website-based control panel (“the Command Center”). Wallet Steering Programs may be deployed to digital and physical channels and through explicit rules. Wallet Steering Programs may be updated in real-time once they are live.

Wallet Steering Programs and their associated marketing campaign elements or components may be deployed via a set of automated rules and mechanics that may be configured by non-technical users of the platform via the Command Center. Mechanics may be based on Wallets, Share of Wallet, Wallet Opportunity, Wallet Capacity, product type, product category, service type, service category, engagement channel, delivery channel, time of day, location, offer redemption capacity (i.e., limit), geo-location of a specific consumer, geo-location of a particular business's store, Wallet Steering Currency stored value balance (such as points), achievement, currency earn, currency burn, communications preference, prior purchase behavior, survey response, consumer preference, consumer member profile, third-party data, end-user device, consumer real-time behavior, and based on many other types of consumer and business data. Examples of mechanics for Wallet Steering Experiences that run as part of a Wallet Steering Program are as follows, which in some provided examples use fictitious brand names for illustrative purposes: (A) Deploy a Wallet Survey, sent automatically to specific consumers within a Dynamic Audience based on real-time purchase behavior within a defined and linked Wallet or sent automatically to a specific Dynamic Audience configuration as defined by a particular business; (B) Deploy a Wallet Steering Experience to a consumer after the consumer completes a Wallet Survey; (C) Deploy a Wallet Steering Experience to a consumer based on an understanding of the consumer's Wallet Opportunity; (D) Deploy a Wallet Steering Experience to a consumer after they purchase a specific product or service; (E) Deploy a Wallet Steering Experience to a consumer immediately upon arrival to a store, before the consumer completes their shopping and ‘checks out’; (F) Only show a Wallet Steering Experience to consumers that are known to represent a specific share of Wallet with a specific product type, product category, service type, or service category; (G) Only show a Wallet Steering Experience to a consumer who is near or at one specific store, located in Philadelphia; (H) Only show a Wallet Steering Experience to a consumer who has purchased at least three of a specific product in a given period of time, such as within a month; (I) Automatically show the consumer a specific set of Wallet Steering Experiences that are personalized for them as soon as the consumer opens a merchant-operated or manufacturer-operated rewards program website; (J) Only show a Wallet Steering Experience to consumers from September 2 to September 15; (K) Automatically send a consumer a Wallet Survey after they visit one of a merchant or manufacturers place of business for the third time, for example; (L) After a consumer purchases a specific product a certain number of times from a consumer packaged goods brand (example: Diet Fizzy Cola) and Open Commerce calculates a variance in Wallets and/or Wallet Opportunity, automatically send that consumer a Wallet Steering Experience to try a competitive consumer packaged goods brand (example: Diet Bubbly Soda) and track whether or not the consumer responds to the Experience, in order to identify whether that consumer may have a different Wallet preference; and/or (M) After a consumer purchases a specific product a certain number of times from a consumer packaged goods brand (example: Pershey's Milk Chocolate Bar) and Open Commerce calculates a variance in Wallets and/or Wallet Opportunity, automatically send that consumer a Wallet Steering Experience to try a similar (or affiliated) product from the same consumer packaged goods company (example: Pershey's Peanut Butter Cups) and track whether or not the consumer responds to the Experience in order to identify whether that consumer has a Wallet for a different but related product type.

Wallet Steering Programs may also have analytics systems associated with them. End users of the platform can view and export detailed usage metrics for their programs, marketing campaigns, Wallet Steering Experiences, digital channels, and applications from the platform.

Wallet Steering Programs may also have professional services associated with them, including but not limited to business consulting services for, namely, Wallet Steering Program strategy and management, Wallet Steering Program implementation, Wallet Steering Program optimization, Wallet Steering Program integrations, Wallet Steering data and insights management, loyalty program strategy and management, consumer communications management, consumer relationship management, payments program strategy and management, consumer cross-channel engagement program strategy and management, consumer acquisition, generating consumer brand loyalty, predicting and manipulating consumer purchasing behavior, business and marketing strategy, digital marketing strategy and program management, promotional offer marketing, product marketing, consumer research, consumer behavior analysis, consumer data analysis, business research, and business data analysis, all for assisting businesses with Wallet Steering.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

Reference will now be made in detail to various exemplary and illustrative embodiments of the present invention.

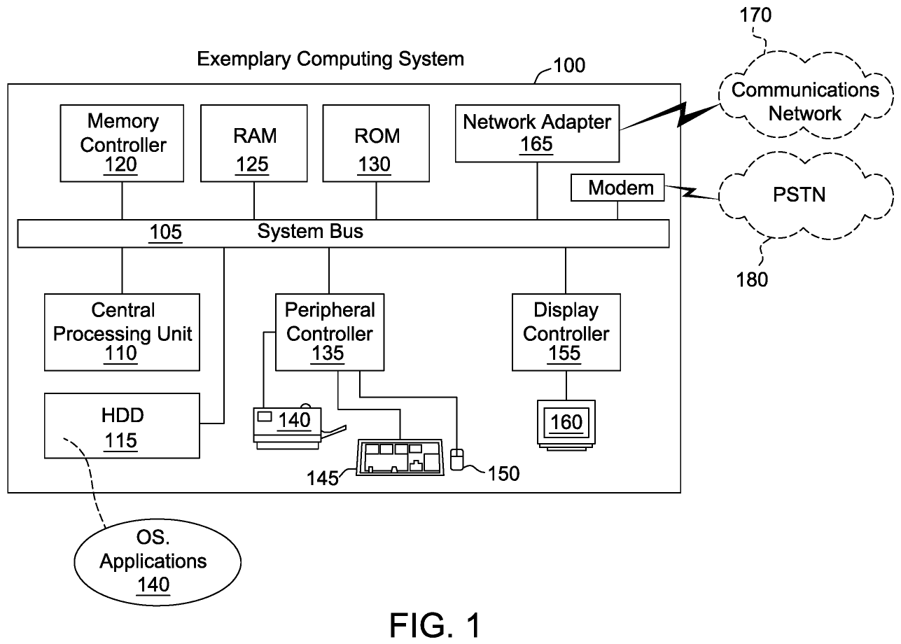

FIG. 1 depicts an exemplary computing system (100) for use in accordance with herein described system and methods. Computing system (100) is capable of executing software, such as an operating system (OS) and a variety of computing applications (190). The operation of exemplary computing system (100) is controlled primarily by computer readable instructions, such as instructions stored in a computer readable storage medium, such as hard disk drive (HDD) (115), optical disk (not shown) such as a CD or DVD, solid state drive (not shown) such as a USB “thumb drive,” or the like. Such instructions may be executed within central processing unit (CPU) (110) to cause computing system (100) to perform operations. In many known computer servers, workstations, personal computers, and the like, CPU (110) is implemented in an integrated circuit called a processor.

It is appreciated that, although exemplary computing system (100) is shown to comprise a single CPU (110), such description is merely illustrative as computing system (100) may comprise a plurality of CPUs (110). Additionally, computing system (100) may exploit the resources of remote CPUs (not shown), for example, through communications network (170) or some other data communications means.

In operation, CPU (110) fetches, decodes, and executes instructions from a computer readable storage medium such as HDD (115). Such instructions can be included in software such as an operating system (OS), executable programs, and the like. Information, such as computer instructions and other computer readable data, is transferred between components of computing system (100) via the system's main data-transfer path. The main data-transfer path may use a system bus architecture (105), although other computer architectures (not shown) can be used, such as architectures using serializers and deserializers and crossbar switches to communicate data between devices over serial communication paths. System bus (105) can include data lines for sending data, address lines for sending addresses, and control lines for sending interrupts and for operating the system bus. Some busses provide bus arbitration that regulates access to the bus by extension cards, controllers, and CPU (110). Devices that attach to the busses and arbitrate access to the bus are called bus masters. Bus master support also allows multiprocessor configurations of the busses to be created by the addition of bus master adapters containing processors and support chips.

Memory devices coupled to system bus (105) can include random access memory (RAM) (125) and read only memory (ROM) (130). Such memories include circuitry that allows information to be stored and retrieved. ROMs (130) generally contain stored data that cannot be modified. Data stored in RAM (125) can be read or changed by CPU (110) or other hardware devices. Access to RAM (125) and/or ROM (130) may be controlled by memory controller (120). Memory controller (120) may provide an address translation function that translates virtual addresses into physical addresses as instructions are executed. Memory controller (120) may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system (100) may contain peripheral controller (135) responsible for communicating instructions using a peripheral bus from CPU (110) to peripherals, such as printer (140), keyboard (145), and mouse (150). An example of a peripheral bus is the Peripheral Component Interconnect (PCI) bus.

Display (160), which is controlled by display controller (155), can be used to display visual output and/or presentation generated by or at the request of computing system (100). Such visual output may include text, graphics, animated graphics, and/or video, for example. Display (160) may be implemented with a CRT-based video display, an LCD-based flat-panel display, gas plasma-based flat-panel display, touch-panel, or the like. Display controller (155) includes electronic components required to generate a video signal that is sent to display (160).

Further, computing system (100) may contain network adapter (165) which may be used to couple computing system (100) to an external communication network (170), which may include or provide access to the Internet. Communications network (170) may provide user access for computing system (100) with means of communicating and transferring software and information electronically. Additionally, communications network (170) may provide for distributed processing, which involves several computers and the sharing of workloads or cooperative efforts in performing a task. It is appreciated that the network connections shown are exemplary and other means of establishing communications links between computing system (100) and remote users may be used.

It is appreciated that exemplary computing system (100) is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

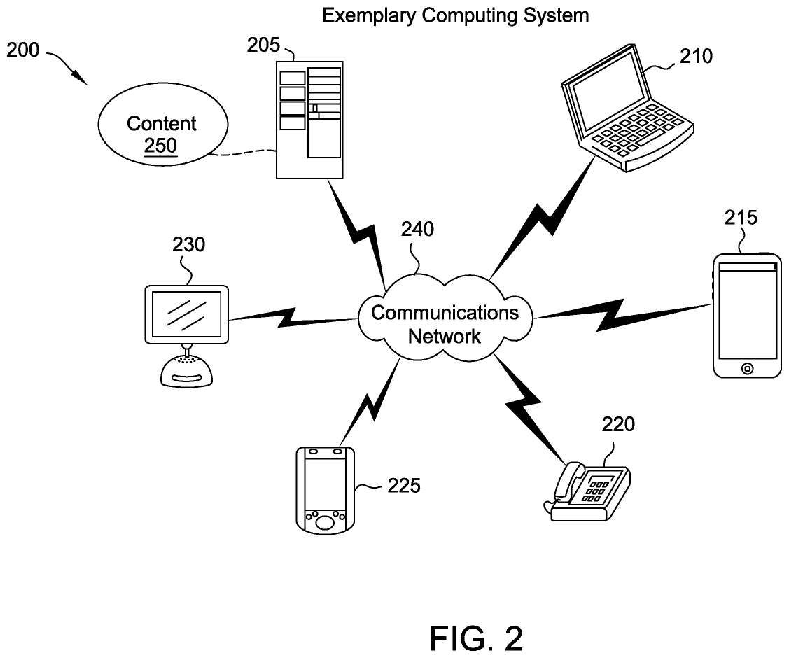

As shown in FIG. 2, computing system (100) can be deployed in a networked computing environment (200). In general, the above description for computing system (100) applies to server, client, and peer computers deployed in a networked environment, for example, server (205), laptop computer (210), and desktop computer (230). FIG. 2 illustrates an exemplary illustrative networked computing environment (200), with a server in communication with client computing and/or communicating devices via a communications network, in which the herein described apparatus and methods may be employed.

As shown in FIG. 2, server (205) may be interconnected via a communications network (240) (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer (210), wireless mobile telephone (215), wired telephone (220), personal digital assistant (225), user desktop computer (230), and/or other communication enabled devices (not shown). Server (205) can comprise dedicated servers operable to process and communicate data such as digital content (250) to and from client devices (210), (215), (220), (225), (230), etc. using any of a number of known protocols, such as hypertext transfer protocol (HTTP), file transfer protocol (FTP), simple object access protocol (SOAP), wireless application protocol (WAP), or the like. Additionally, networked computing environment (200) can utilize various data security protocols such as secured socket layer (SSL), pretty good privacy (PGP), virtual private network (VPN) security, or the like. Each client device (210), (215), (220), (225), (230), etc. can be equipped with an operating system operable to support one or more computing and/or communication applications, such as a web browser (not shown), email (not shown), or the like, to interact with server (205).

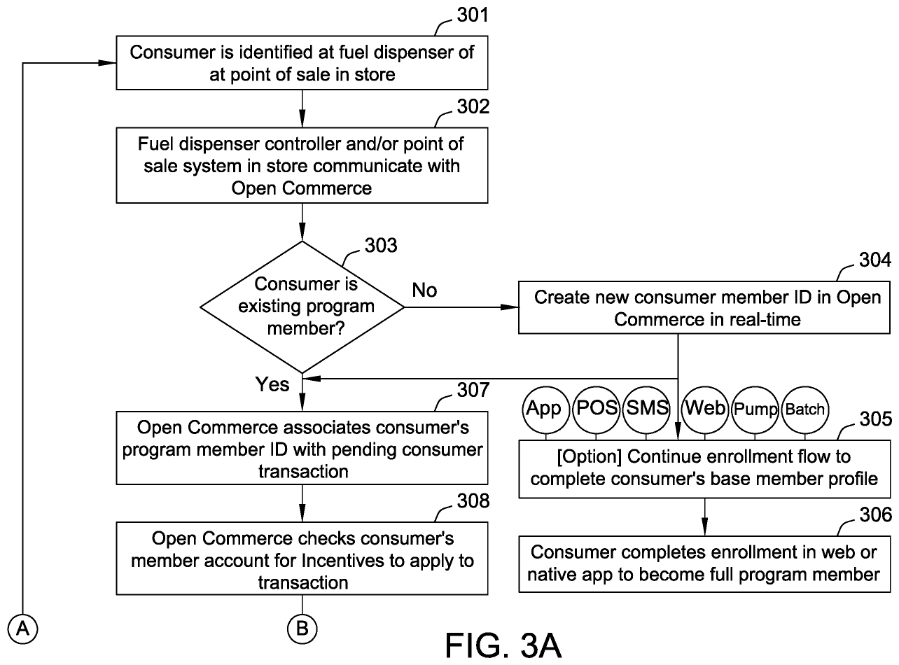

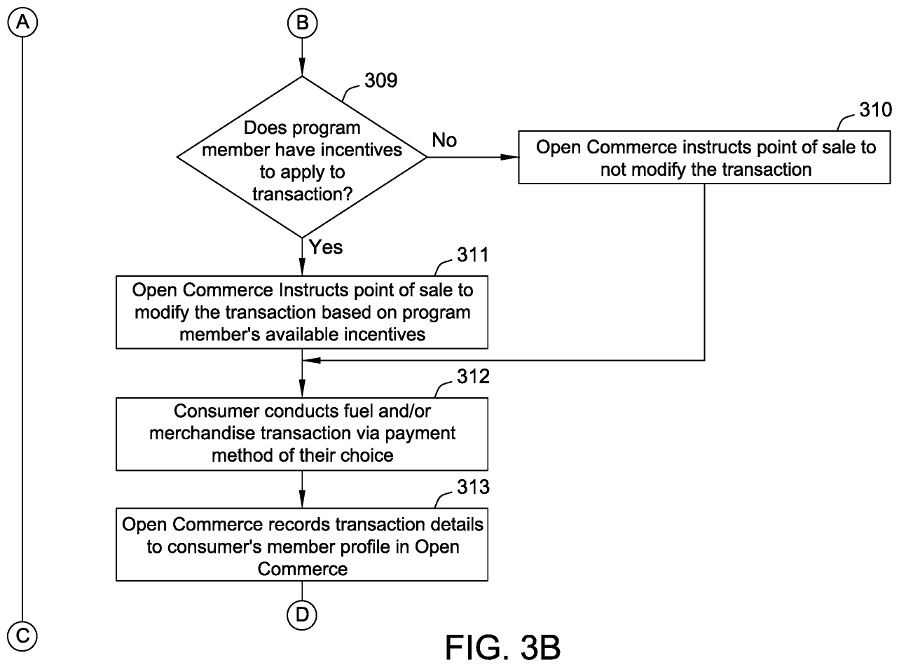

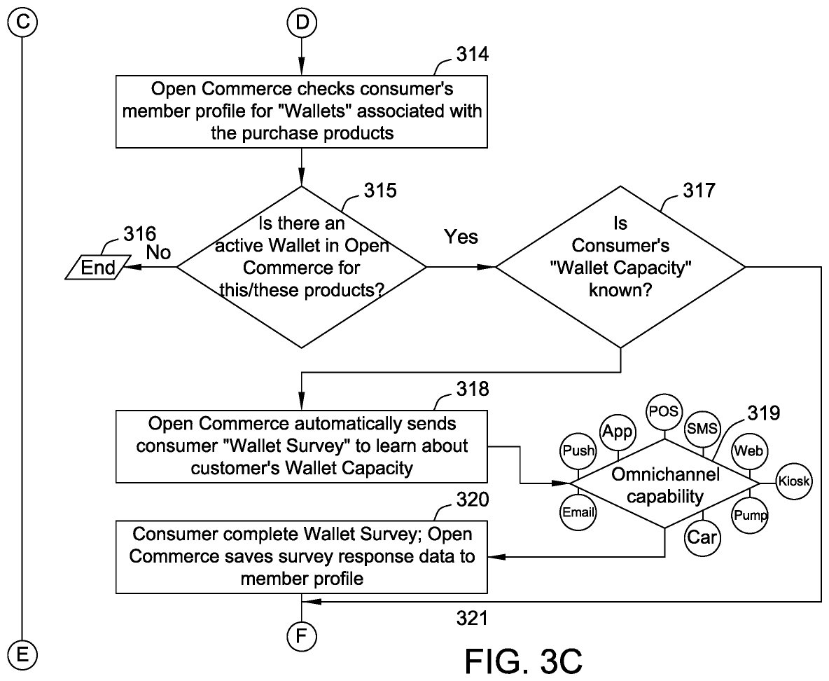

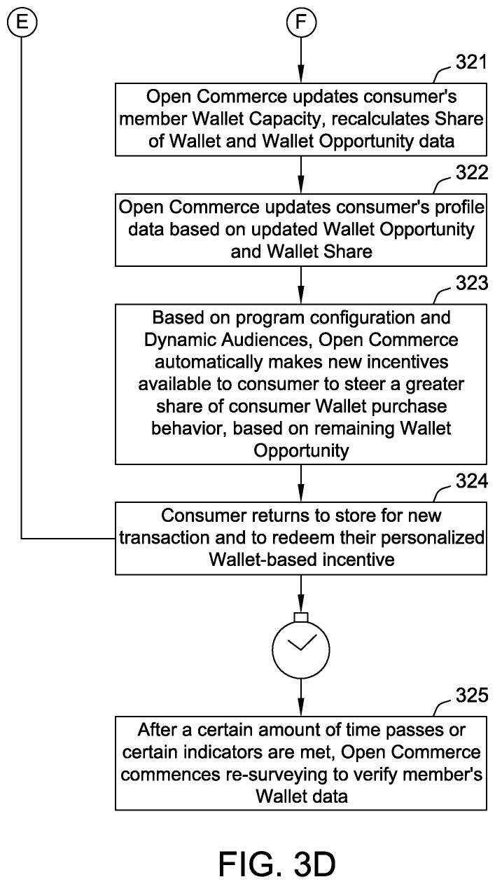

FIGS. 3A-3D illustrate a flow chart illustrating exemplary steps of Wallet Steering, an embodiment of a method of identifying a consumer, converting them into a Wallet Steering Program member, identifying their purchase behavior, and acquiring more purchase behavior from the consumer. As seen in FIGS. 3A-3D, a consumer (301) arrives at a retail store location which has fuel (gasoline) offered out front and a physical store selling products and services (example: convenience store). Upon arriving at the fuel dispenser (pump) or inside at the store's point of sale, the consumer is identified, either by self-identifying, or being identified automatically. The fuel dispenser controller and/or point of sale system in the store sends the consumer's member ID to Open Commerce (302). Open Commerce checks the retailer's database, which is stored inside Open Commerce, to determine whether that consumer's member ID is already on file as a member of the retailer's program, or not (303). If the consumer is not currently a member, the flow proceeds to (304). If the consumer is currently a member, the flow proceeds to (307). At (304), Open Commerce creates a new consumer member ID in its database in real-time and triggers an enrollment flow, including options for enrollment via mobile app, directly on the point of sale keypad and display, via SMS text messaging, via a website or progressive web app, or via the fuel dispenser keypad and display (options for enrollment illustrated in the flow diagram at 305). At (304), the consumer may be considered a partial member as at that time, if only their phone number is known. Open Commerce also enables batch uploading to create many memberships at the same time via a file upload and/or programmatic data transfer. The consumer selects their preferred device or location for enrollment and has an option to continue through a more detailed enrollment flow to provide additional personal data (305). After the consumer has completed enrollment, the consumer is considered a full program member as important personal data is appended to the consumer's member profile in Open Commerce (306). At (307), the consumer has already initiated a purchase/transaction by creating a basket of products at the store, such as a fuel purchase/transaction or a purchase/transaction in the store for products (such as food or beverages) and has already been identified as a program member. Open Commerce associates the current pending purchase/transaction with the consumer's program member ID via programmatic interaction with the point of sale system in the store. Open Commerce checks the configurations in its system and checks the consumer's member account to identify any incentives (example: an available discount for a specific product type) for which this consumer is eligible and which should be applied to the current pending purchase/transaction (308). Open Commerce then makes a real-time decision on how to handle the purchase/transaction based on the program member's available incentives and the priority of the available incentives to apply to the current pending purchase/transaction (309). If the member does not have incentives, Open Commerce instructs the point of sale system in the store to not modify the purchase/transaction (310). If the member does have incentives, Open Commerce instructs the point of sale system in the store to modify the purchase/transaction based on the instructions in Open Commerce for the incentives (examples: cents off per gallon of fuel pumped, percentage discount on a product, buy one product and get a 2nd of the same product free) (311). The consumer completes their fuel and/or merchandise purchase/transaction via the payment method of their choice (examples: cash, credit card, debit card, digital/mobile payment tender) (312). Open Commerce records the final purchase/transaction data from (312) and the line item purchase details of the purchase/transaction into the member's profile in Open Commerce (313). Open Commerce checks the consumer's member profile for any Wallets associated with the purchased products from the previous purchase/transaction (example: a Fuel Wallet, a Food Wallet, a Beverage Wallet) (314). Open Commerce makes a real-time decision based on the Wallet data stored in its system (315). If there is not an active Wallet in Open Commerce for any of the products purchased, the flow ends at (316). When there are one or multiple Wallets defined in Open Commerce and associated with the purchased products, the flow continues to (317). Open Commerces checks the consumer's member profile and specifically, the Wallet Capacity data element associated with the Wallets to identify whether or not the consumer's Wallet Capacity is known for the purchased products that relate to the Wallets from the prior purchase/transaction, which ended at (312) (example: for fuel, if Wallet Capacity is known, Open Commerce will have data on how many gallons of fuel the consumer typically purchases over a given period of time from all the retailers they shop) (317). If Wallet Capacity is known, the flow continues to (321). When Wallet Capacity is not known, the flow continues to (318). Because Open Commerce does not yet know the consumer's wallet capacity for a Wallet or set of Wallets, Open Commerce automatically sends the consumer a Wallet Survey to learn about the consumer's Wallet Capacity relating to the Wallets from the prior purchase/transaction (318), which ended at (312). Open Commerce has an omnichannel capability for Wallet Survey delivery (319), meaning the survey may be sent to the consumer via a number of delivery channels, including push messaging on iOS or Android operating systems, native mobile apps, on the display screen and keypad at the point of sale system, SMS text messaging, a website or progressive web app, a kiosk, on the display screen and keypad at the fuel dispenser (pump), a connected car screen infotainment application, or email. The consumer completes the Wallet Survey, providing Wallet Capacity data for the identified Wallets (320). Open Commerce saves said Wallet Capacity data from the consumer's survey response to the consumer's member profile in Open Commerce. Open Commerce then, based on the updated Wallet Capacity data, calculates Share of Wallet and Wallet Opportunity (example: if a consumer's Wallet Capacity for fuel in a given month is 40 gallons and it is know that the consumer has purchased only 10 gallons of fuel in the past month with the retailer where they completed the fueling purchase/transaction, then it is known that the retailer's share of the Fuel Wallet is 10 gallons, or 25% of the Wallet Capacity, and the Wallet Opportunity is 30 gallons, or 75% of the Wallet Capacity) (321). Open Commerce then updates the consumer's membership data in Open Commerce based on the updated Wallet Opportunity and Share of Wallet data (322). Based on Wallet Steering Program configuration and Dynamic Audiences, Open Commerce automatically makes new incentives available to the consumer to steer a greater share of the consumer's Wallet Opportunity to the retailer (323). After having received the new incentives available to them, the consumer returns to the store for a new purchase/transaction and to redeem their personalized Wallet-based incentive (324). The flow then returns to (301) when the consumer has returned for a new purchase/transaction. After a certain amount of time passes or certain Wallet-related indicators are met, Open Commerce commences re-surveying to verify member's Wallet data (325).

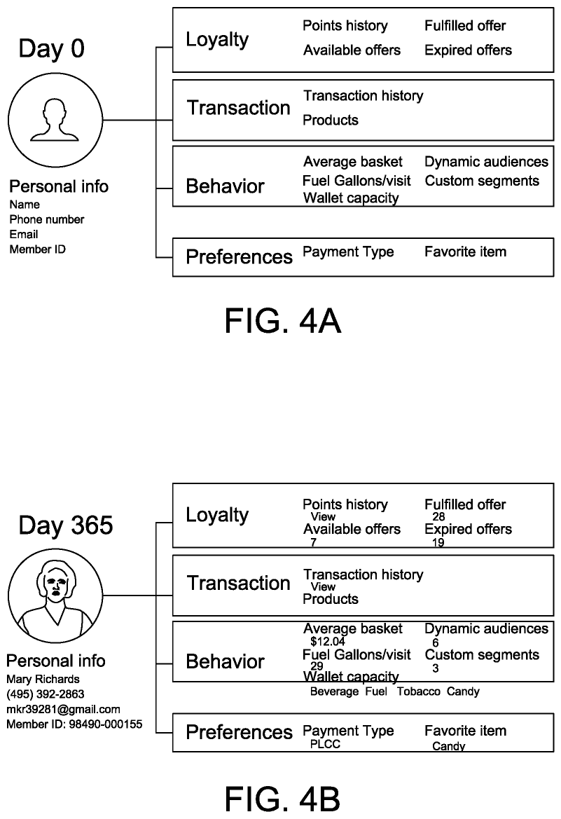

FIG. 4A is an exemplary consumer profile before setup and FIG. 4B is an exemplary consumer profile after it has been built on over time based on transactions associated with the consumer identifier, as described in more detail below.

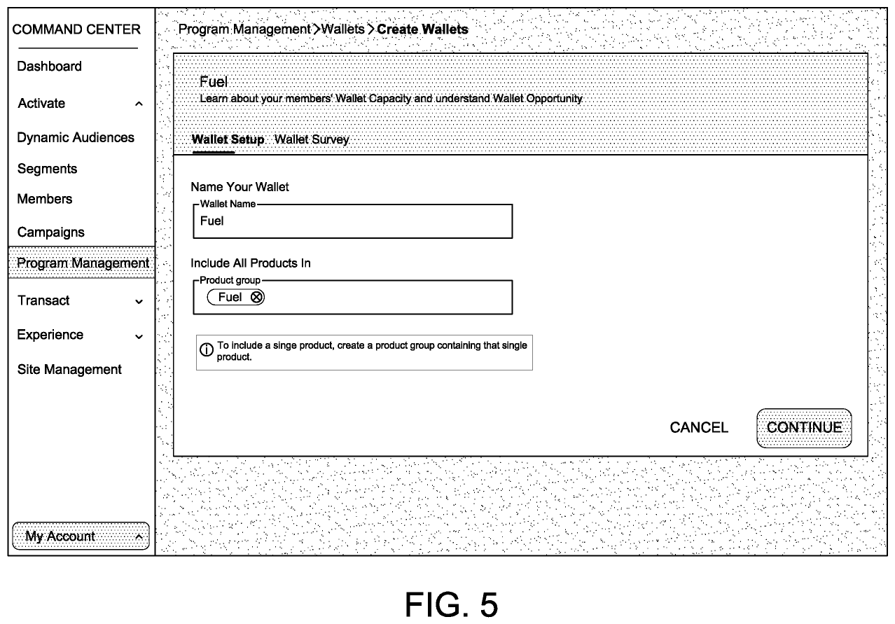

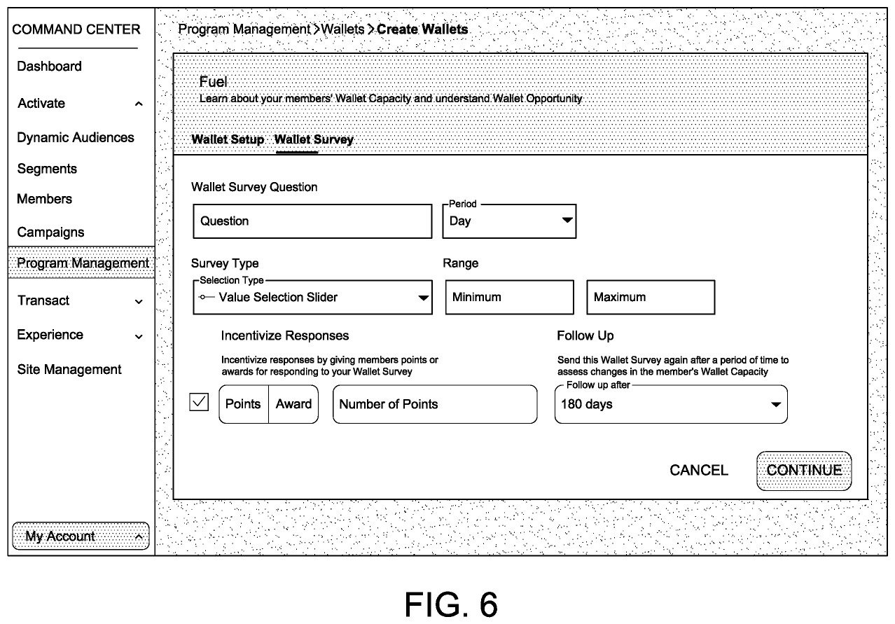

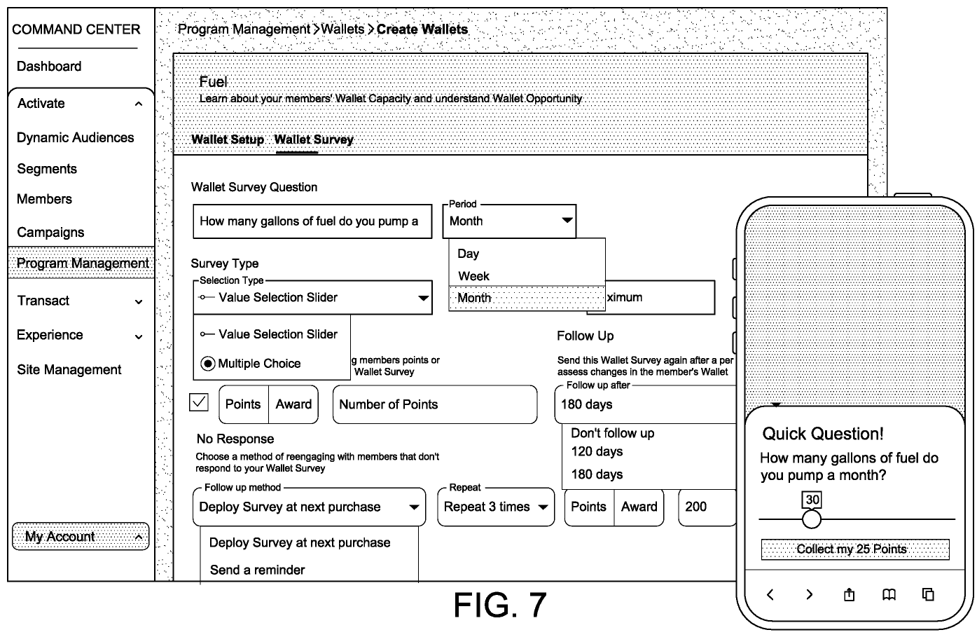

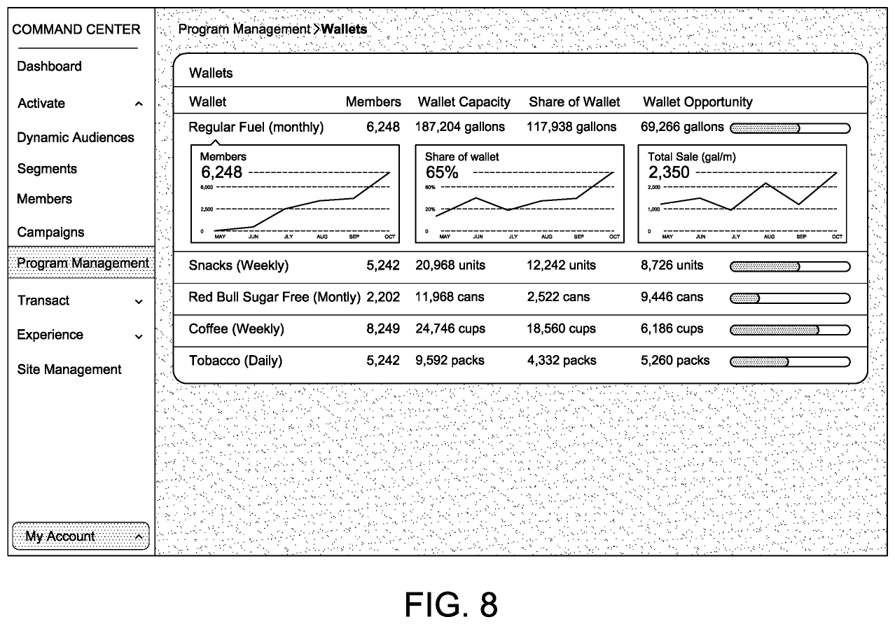

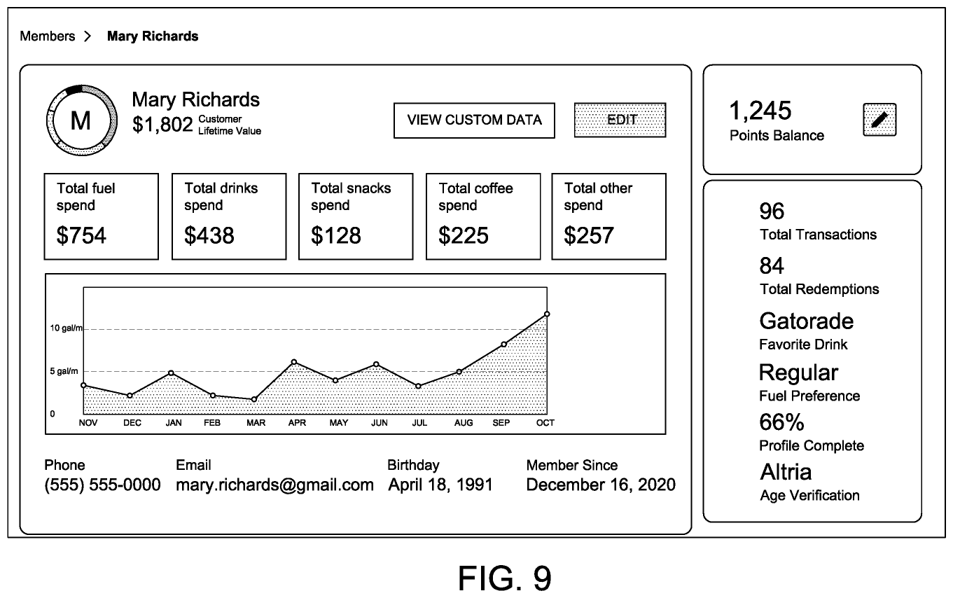

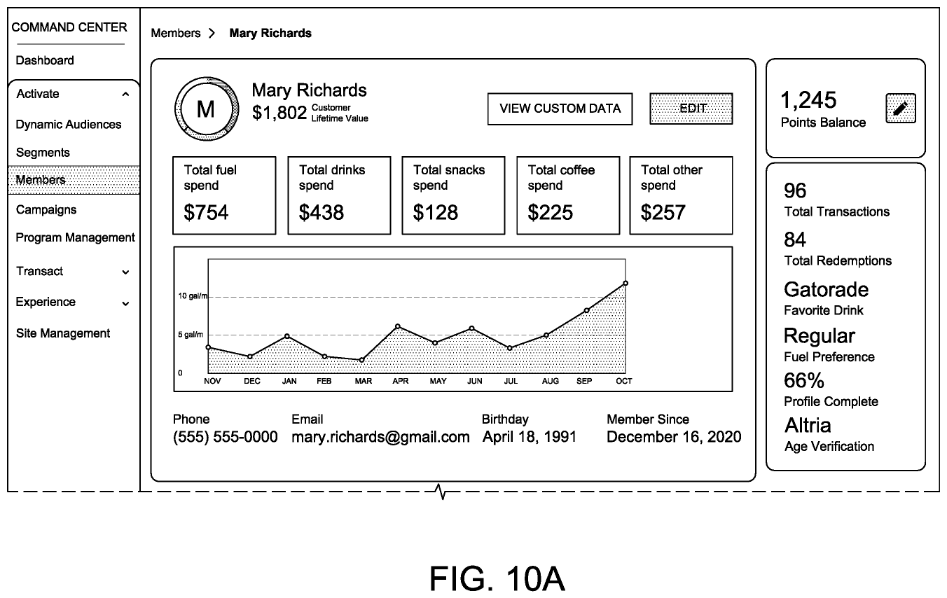

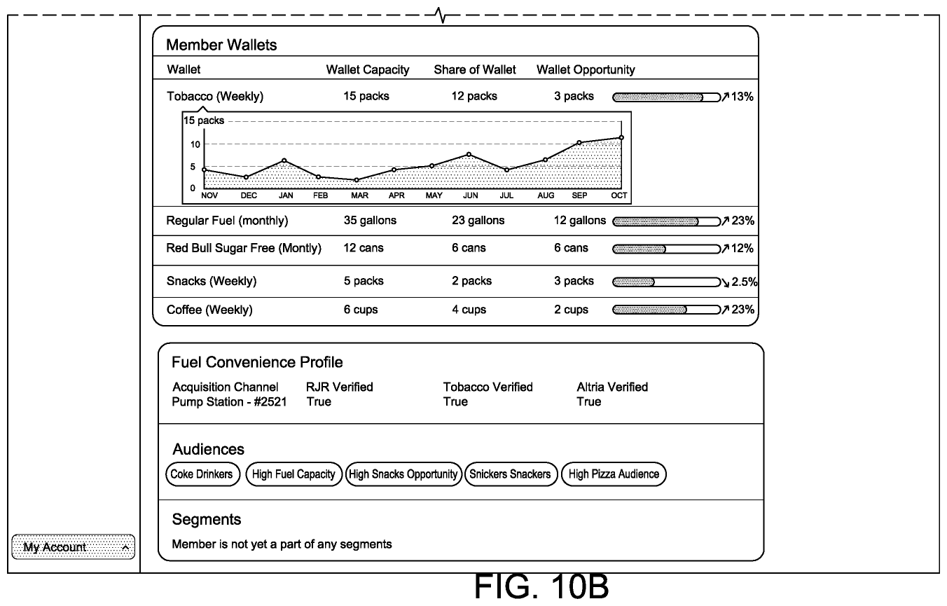

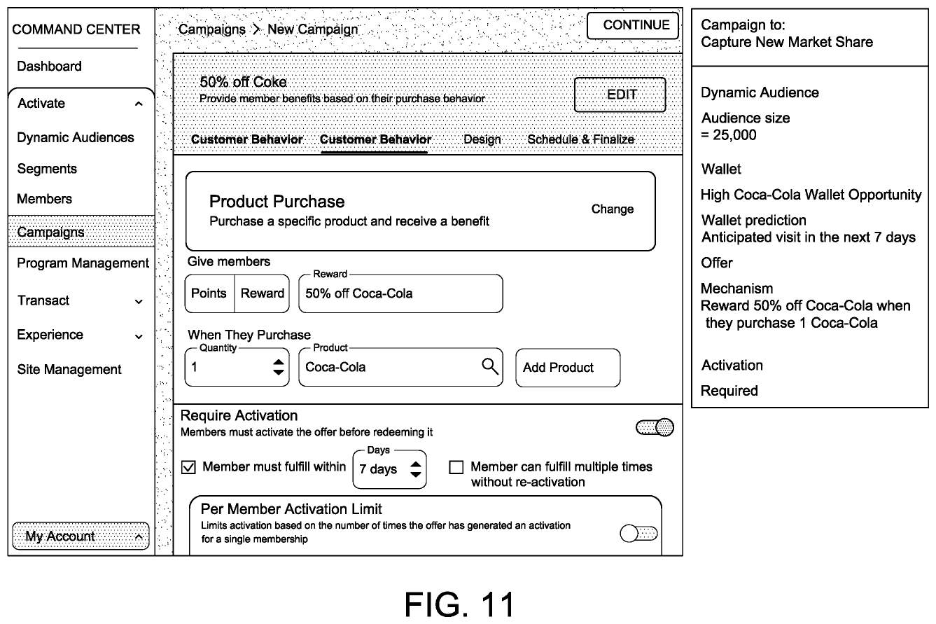

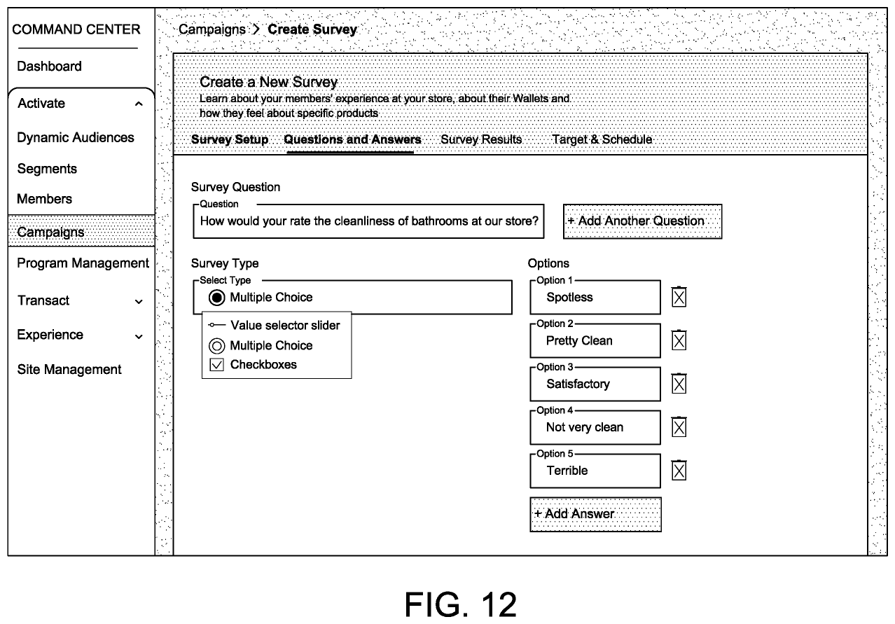

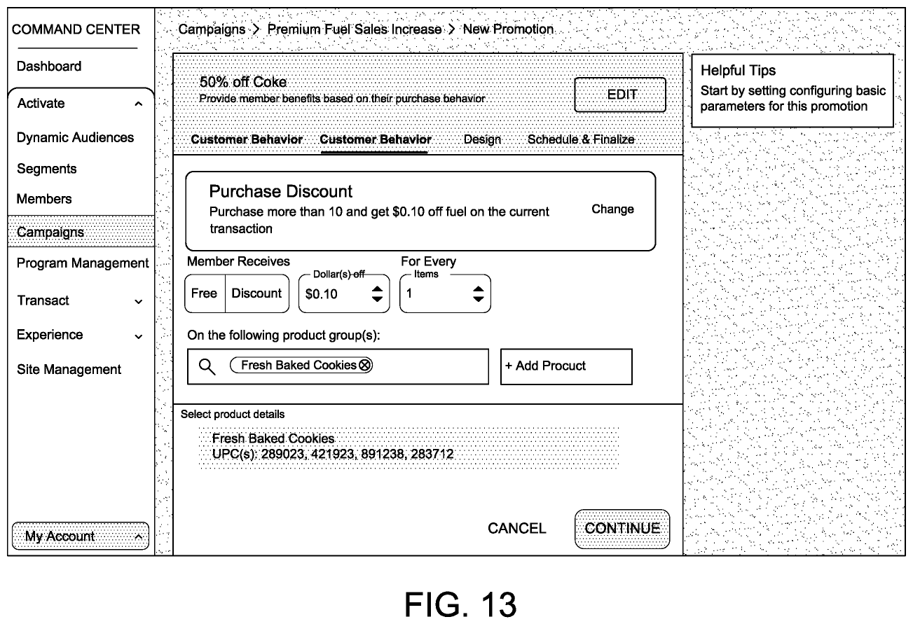

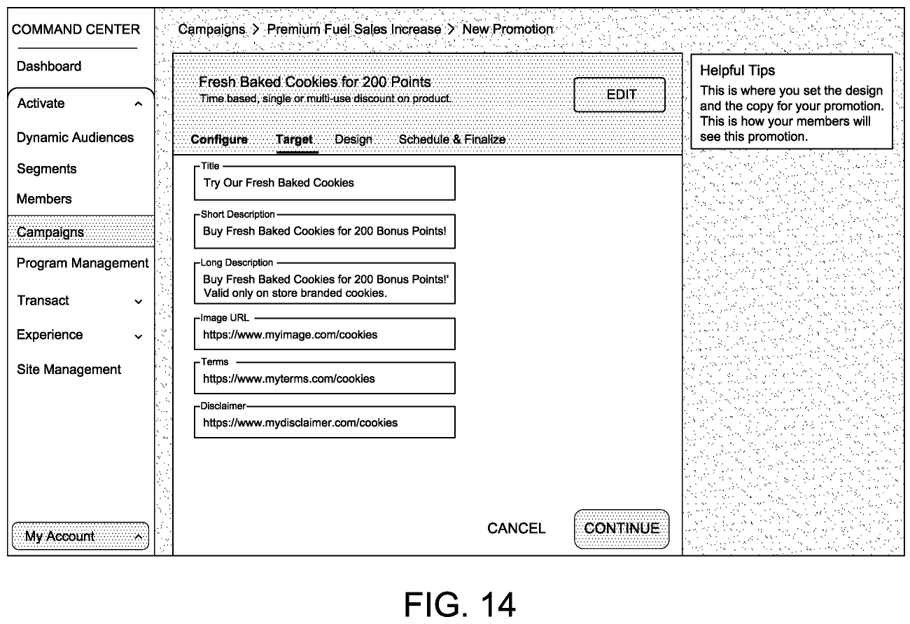

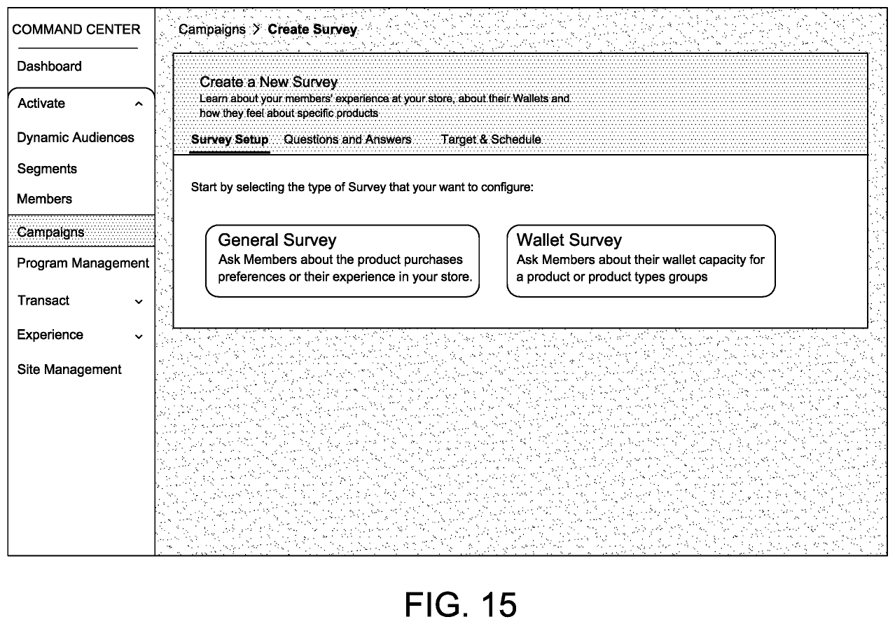

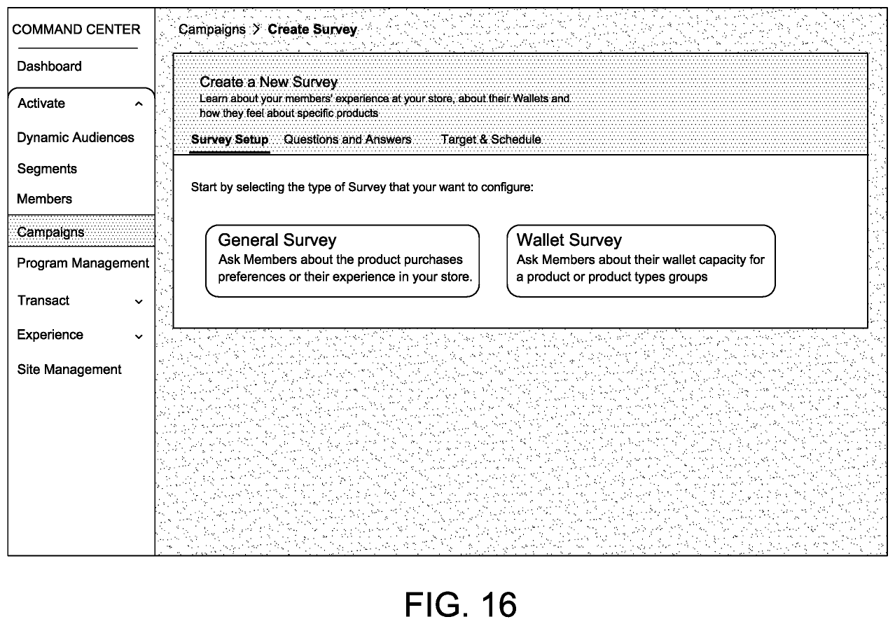

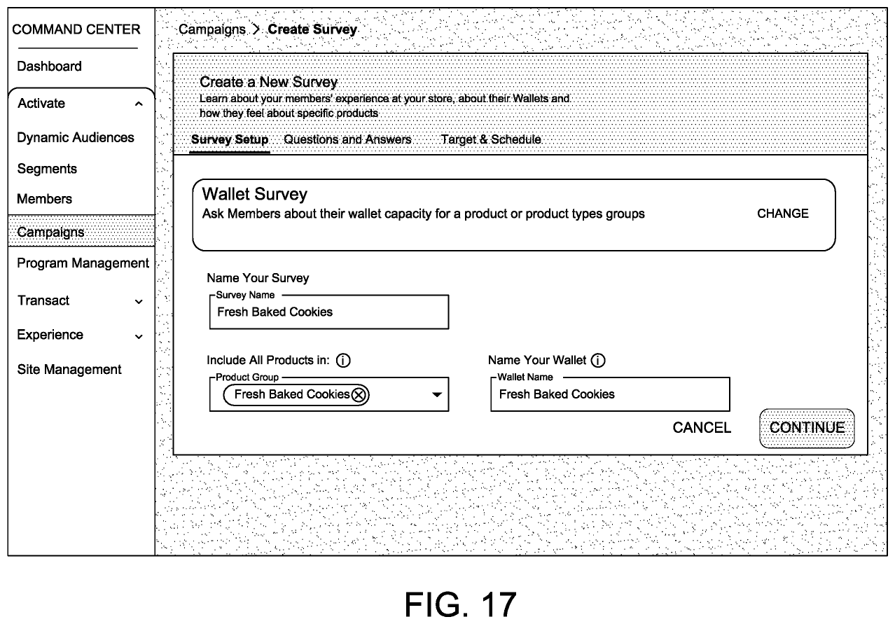

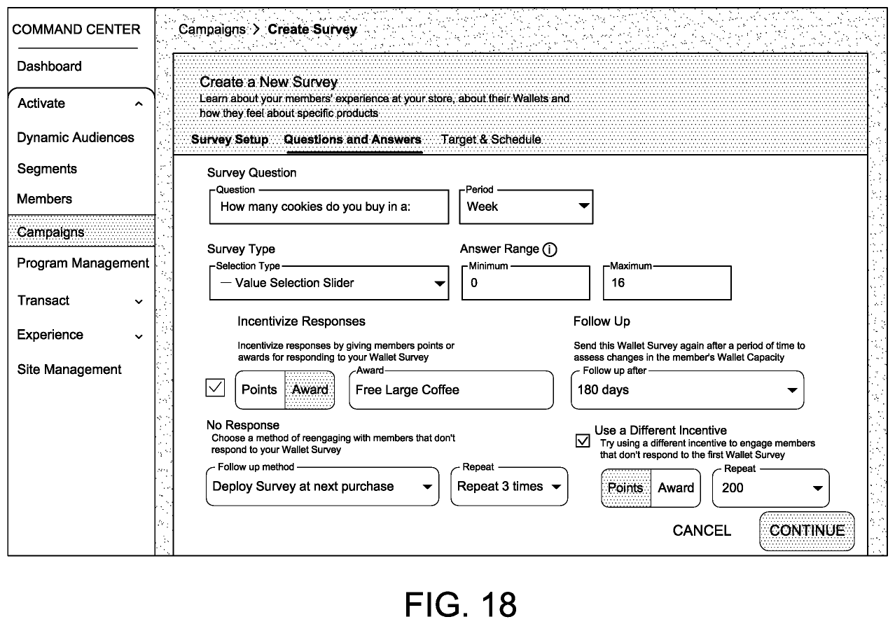

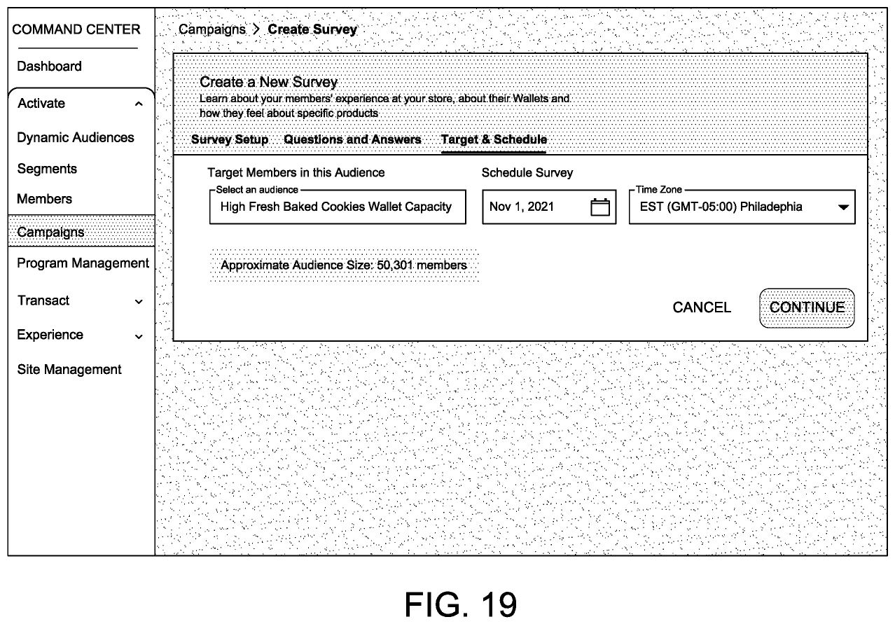

FIGS. 5 through 19 are exemplary Open Commerce Command Center user interface screens, showing various aspects of how businesses use Open Commerce for Wallet Steering, including the configuration of (A) Wallets, (B) Wallet Surveys, (C) Member Profiles, (D) Dynamic Audiences, (E) Wallet Steering Experiences, and (F) Reporting, and are provided as exemplary, not limiting.

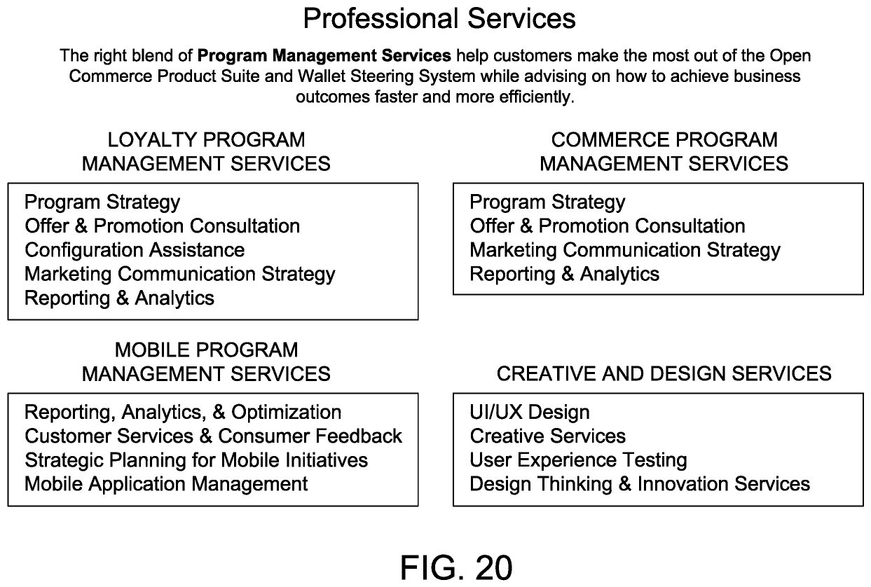

FIG. 20 provides descriptions of exemplary services provided by Stuzo to businesses in conjunction with Wallet Steering.

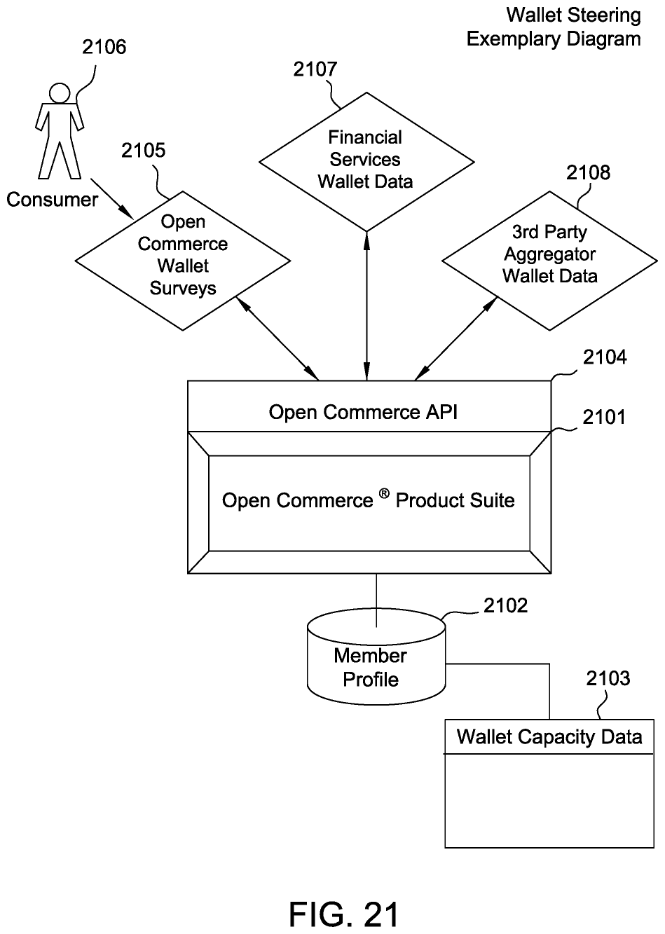

FIG. 21 is an illustrative diagram depicting the multiple methods for acquiring Wallet Capacity data. As Wallet Capacity data is necessary for calculating a Wallet Steering Program member's Wallet Opportunity, providing multiple methods for acquiring Wallet Capacity data ensures the users of the Wallet Steering invention are empowered to take advantage of several Wallet Capacity data sources. Stuzo's Open Commerce product suite (2101) includes a member profile database (2102). Within the Open Commerce member profile database are tables which include program member profile Wallet-related data. Within a member profile, exists tables that house Wallet Capacity data, specific to each program member (2103). The Open Commerce product suite includes the Open Commerce API (2104), a programming interface that provides the capability for ingesting Wallet Capacity data from external sources (shown in items 2105, 2107 and 2108). Open Commerce provides a feature which sends consumers a Wallet Survey (2105) (also separately illustrated in FIGS. 3A-3D). When consumers (2106) respond to a Wallet Survey, the corresponding Wallet Capacity data is ingested by the Open Commerce API (2104), and saved into the member profile database within Wallet Capacity data tables (2103). There are additional methods for ingesting Wallet Capacity data and saving the data to Wallet Capacity data tables. For example, Financial Services companies, such as credit card issuing banks or payment processors, may be able to provide Wallet Capacity data (2107). 3rd Party Data aggregator businesses, such as companies that aggregate consumer shopping, behavior, and/or product preference data from multiple sources, may be able to provide Wallet Capacity data (2108). These sources all have the capability of sending Wallet Capacity data into Open Commerce via the Open Commerce API (2104) and/or providing data files for batch upload into Open Commerce.

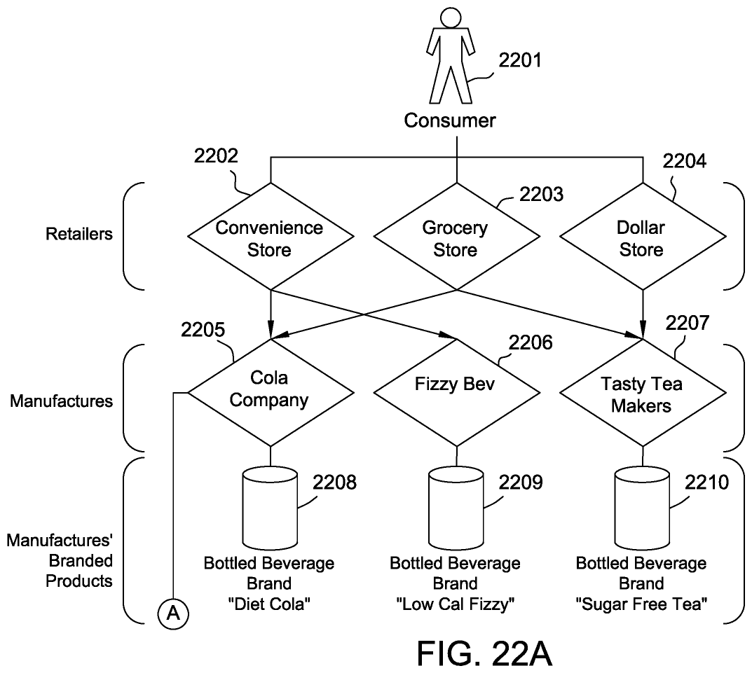

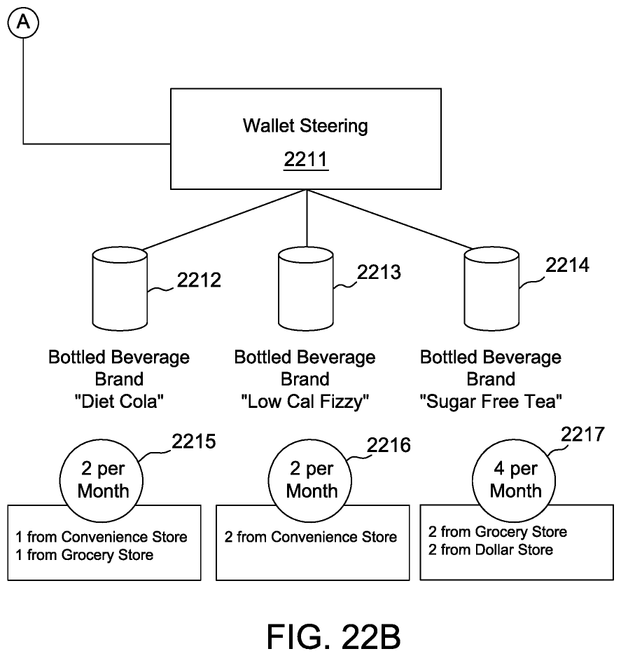

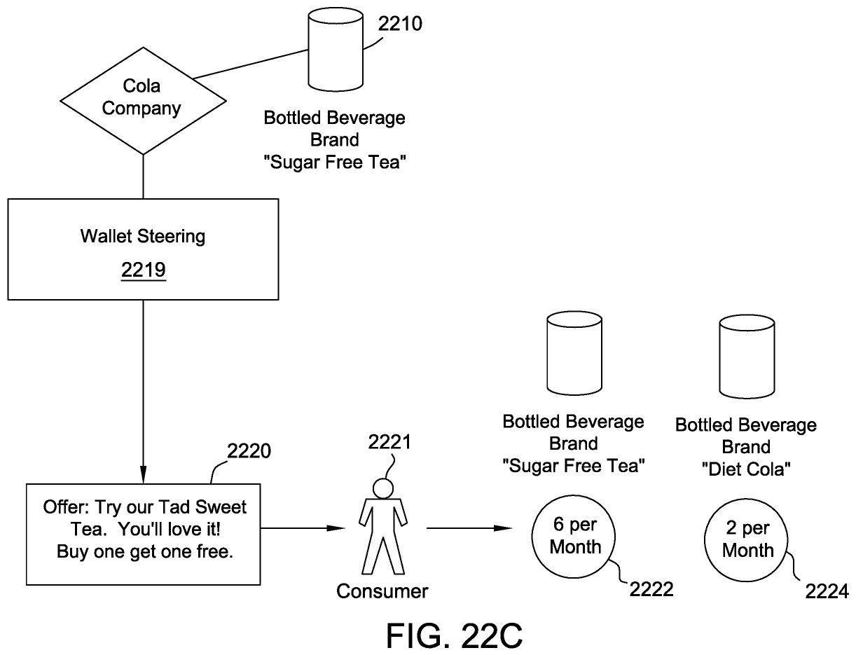

The following description, which for clarity and illustration includes fictitious product manufacturer names and fictitious manufactured branded product names, refers to FIGS. 22A-22C. In this illustrative diagram depicting typical consumer purchase behavior, a consumer (2201) goes to multiple different retail businesses (2202 through 2204) to purchase bottled beverages, consisting of multiple different bottled beverage brands (2208 through 2210), which are offered by multiple different consumer packaged goods (“CPG”) manufacturers (2205 through 2207). This distribution of Wallet spend behavior from consumers across multiple CPG manufacturers typically exists in a many to many relationship wherein the consumer does not always purchase the same CPG bottled beverage brand, nor do they purchase the brands they prefer from the same retail business. In the transaction examples, (2201 through 2210) we'll consider each a Wallet Steering Program transaction as the consumer is a known member in the retailer's program, thereby enabling the retailer to have a comprehensive line-item understanding of the consumer's transaction details, products purchased, quantities, prices, discounts, and so on, thus enabling the calculation of Share of Wallet and the Wallet Opportunity. For clarity, the consumer (2201) may visit a Convenience Store (2202). At the Convenience Store, the consumer may, on one visit, purchase a Diet Cola bottled beverage (2208), which is offered by the CPG named Cola Company (2205) and on a separate visit to the same Convenience Store, purchase a Low Cal Fizzy bottled beverage (2209), which is offered by the CPG named Fizzy Bev (2206). That same consumer may visit a Grocery Store (2203) and at the Grocery Store, on one visit, purchase a Diet Cola bottled beverage and on a separate visit, purchase a Sugar Free Tea (2210), which is offered by the CPG named Tasty Tea Makers (2207). That same consumer may visit a Dollar Store (2204) and purchase a Sugar Free Tea. In this typical situation, Cola Company, the CPG manufacturer, does not know how many bottled beverages the consumer is buying across any given period of time, does not know all the retailers the consumer buys bottled beverages from, and/or does not know all the different CPG bottled beverage brands the consumer likes to buy. If Cola Company had access to the Wallet Steering invention (2211), Cola Company could know that within the consumer's bottled beverages, the consumer is buying a total of eight bottled beverages per month (the consumer's bottled beverage Wallet Capacity), and that the consumer's Wallet Capacity is distributed as such: two Diet Cola bottled beverages per month, one from the Convenience Store and one from the Grocery Store; two Low Cal Fizzy bottled beverages per month, both from the Convenience store; and four Sugar Free Tea bottled beverages, two from the Convenience Store and two from the Dollar Store (2212 through 2217). Now, imagine that Cola Company offers a bottled beverage brand named Tad Sweet Tea (2218) that is competitive to the Sugar Free Tea brand offered by Tasty Tea Makers. Cola Company would be very interested in steering a greater share of the consumer's bottled beverage Wallet to Cola Company's brand portfolio. Using Wallet Steering (2219), Cola Company would have unique and powerful capabilities for targeting the consumer based on precisely known Share of Wallet, Wallet Capacity, and the Wallet Opportunity (2221), with highly personalized Wallet Steering Experiences (2220) to incentivize the consumer to try Tad Sweet Tea. Over time, Cola Company could, using Wallet Steering, acquire a greater share of the consumer's bottled beverage Wallet Capacity, such as six Tad Sweet Tea purchases per month (2222). Assuming the consumer's Diet Cola purchase behavior remained the same, at two purchases per month (2224), the Tad Sweet Tea purchase behavior change would be a net of six additional bottled beverage purchases for Cola Company, for a total of eight total bottled beverage purchases from the consumer per month, a 300% net incremental increase in the consumer's Share of bottled beverage Wallet to Cola Company. Now, imagine this same 300% net incremental increase in Cola Company's Share of bottled beverage Wallet (represented by six additional bottled beverages per consumer per month) happening with not just one consumer, but with five million consumers that all purchase bottled beverage brands offered by Cola Company. Six incremental bottled beverages per consumer per month across one year with five million consumers would yield a total of 360 million incremental bottled beverages sold by Cola Company per year.

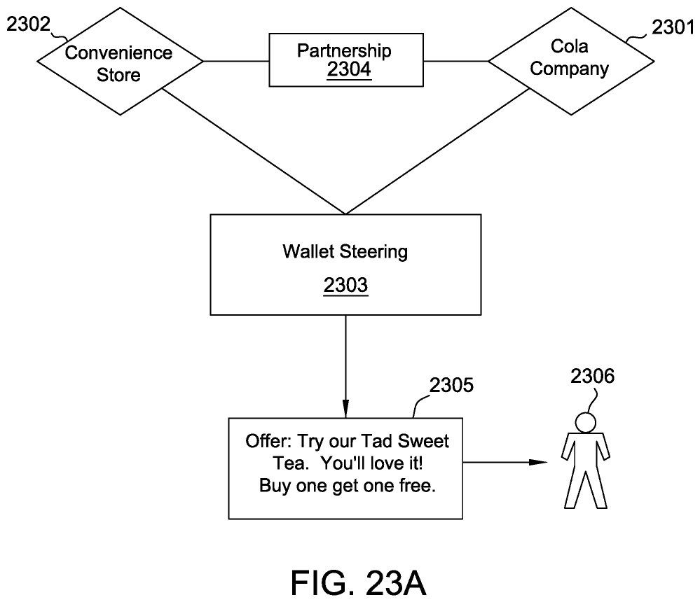

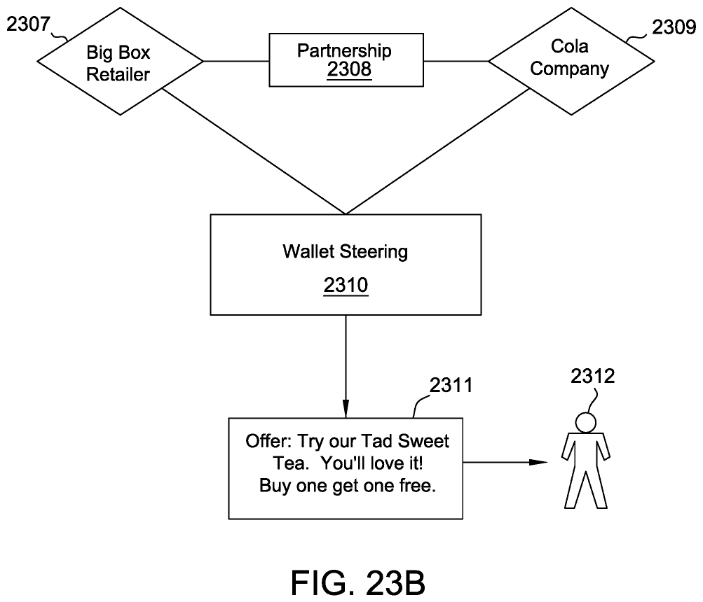

To illustrate an additional unique power of Wallet Steering, we will reference the concepts established in FIGS. 22A-22C and incorporate two new partnership concepts in FIGS. 23A-23B. The following description, which for clarity and illustration includes fictitious retailer business names, fictitious product manufacturer names, and fictitious manufactured branded product names, refers to FIGS. 23A-23B: Imagine that Cola Company (2301) and a Convenience Store operator (2302) (both referenced in FIGS. 22A-22C) were both users of Wallet Steering (2303). Given Cola Company and the Convenience Store operator are already using Wallet Steering, both businesses already have an understanding of their consumers' Wallets, Wallet Capacity, their Share of Wallet, and the Wallet Opportunity. Additionally, imagine that Cola Company and the Convenience Store operator had a partnership (2304) and in that partnership, Cola Company agreed to fund a set of limited time offers (2305) via Wallet Steering Experiences for Tad Sweet Tea, made available to a Convenience Store operator, which routinely keeps Tad Sweet Tea in stock. This could lead to a mutually positive business outcome for both Cola Company and the Convenience Store operator, as it would be possible to steer the consumer's (2306) Tad Sweet Tea purchase behavior to a specific Convenience Store operator's business. Building on the Wallet Steering concept illustrated in the section immediately above, if the Convenience Store operator and Cola Company mutually had five million consumers that all purchase bottled beverage brands offered by Cola Company, six incremental bottled beverages per consumer per month across one year with five million consumers would yield a total of 360 million incremental bottled beverages sold per year. As an additional illustration, imagine that Cola Company (2309) and a massive Big Box Retail operator (2307) with over 10,000 warehouse sized stores and a huge e-commerce/online store, serving hundreds of millions of consumers, were both users of Wallet Steering (2310). Given Cola Company and the Big Box Retail operator are already using Wallet Steering, both businesses already have an understanding of their consumers' Wallets, Wallet Capacity, their Share of Wallet, and the Wallet Opportunity. Additionally, imagine that Cola Company and the Big Box Retail operator had an exclusive partnership (2308) and in that exclusive partnership, Cola Company agreed to fund a set of limited time offers (2311) via Wallet Steering Experiences for Tad Sweet Tea available exclusively to the Big Box Retail operator, which routinely keeps Tad Sweet Tea in stock. Cola Company's Wallet Steering Experience might be offered exclusively to the Big Box Retail operator due to Big Box's massive scale, distribution and capabilities for selling Cola Company products to over a hundred million consumers (2312). This could lead to a mutually positive business outcome for both Cola Company and the Big Box Retail operator, as it would be possible to steer most of the consumer's (2306) Tad Sweet Tea purchase behavior to the Big Box Retail operator's business. Building again on the same Wallet Steering concept illustrated in the section immediately above, if the Big Box Retail operator and Cola Company mutually had twenty million consumers that all purchase bottled beverages, six incremental Cola Company bottled beverages per consumer per month with Big Box Retail, across one year with twenty million consumers, would yield a total of 1.44 billion incremental bottled beverages sold per year.

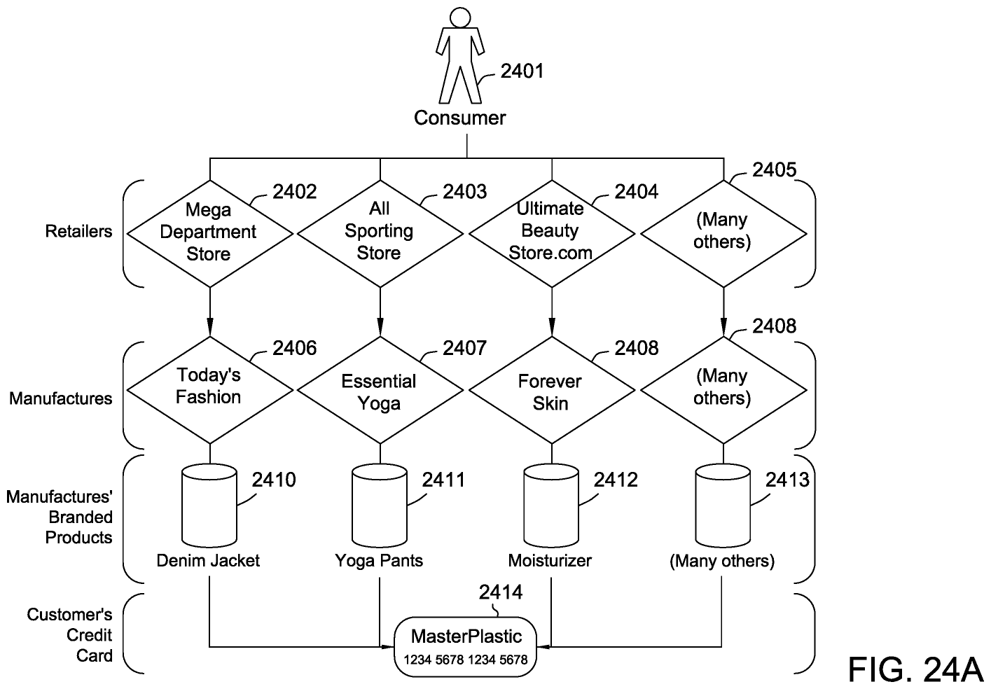

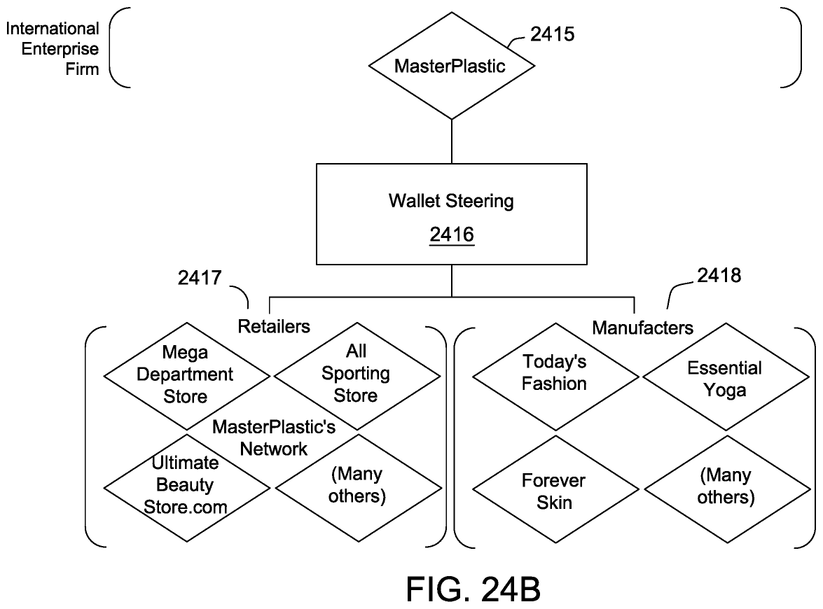

Wallet Steering also has the capability for empowering large global enterprise business operators, such as credit card networks, technology firms, payment processing and merchant banking services firms, and the like (given their unique position with vast amounts of consumer Wallet data, transactional data, and product preference data) to ‘Steer All the Wallets.’ To illustrate the additional unique power of Steering All the Wallets, we will build upon the Wallet Steering concepts established in FIGS. 3A-3D (Wallet Steering for identifying consumer and learning about Wallet Capacity, Share of Wallet, and Wallet Opportunity) and FIG. 21 (Wallet Steering for multiple methods of capturing Wallet Capacity data), incorporating a new Steering All the Wallets concept, illustrated in FIGS. 24A-24B. The following description, which for clarity and illustration includes fictitious retailer business names, fictitious product manufacturer names, fictitious manufactured branded product names, and fictitious global enterprise firm names, refers to FIGS. 24A-24B: Imagine a consumer (2401) visits many different retail establishments, both brick and mortar and E-Commerce stores, such as Mega Department Store, All Sporting Store, UltimateBeautyStore.com, and many others (2402 through 2405). At these retail locations, the consumer buys many different kinds of products, such as Denim Jackets, Yoga Pants, Moisturizer, and many others (2410 through 2413), which are offered from many different product manufacturers, such as Today's Fashion, Essential Yoga, Forever Skin, and many others (2406 through 2409). This situation is typical for most all consumers. Imagine the same consumer has a credit card issued in their name from a global credit card issuing firm called MasterPlastic (2414) and that the consumer uses this same MasterPlastic credit card to buy all the products from all the retailers (2402 through 2413). In this situation, the global credit card issuing firm, MasterPlastic, has a unique and vast view into consumers' Wallets and Wallet purchase behavior. Now imagine MasterPlastic (2415) has a license to use Wallet Steering (2416). MasterPlastic would then have access to capabilities for understanding Wallet, Wallet Capacity, Share of Wallet, and Wallet Opportunity data, with an even greater purview compared with an individual retailer or manufacturer, as MasterPlastic is uniquely positioned in the market to see consumer transactions spanning many different types of retailers, many different manufacturers, and many different branded products. MasterPlastic could then offer Wallet Steering capabilities directly to its tens of thousands of retailer customers which accept MasterPlastic cards for payment in their stores, to Steer All the Wallets of the many millions of consumers that use MasterPlastic cards for payment across the tens of thousands of retailers in MasterPlastic's network (2417). Further, MasterPlastic could offer Wallet Steering capabilities directly to the tens of thousands of product manufacturers (2418) for which it has insights into Wallet Capacity and Share of Wallet data for the millions of consumers that use MasterPlastic cards for payment across the tens of thousands of retailers in MasterPlastic's network. If MasterPlastic had the capability to Steer All the Wallets, it would give MasterPlastic a significant and unfair advantage over their competitors as it would give retailers in MasterPlastic's network (2417) a reason to ask consumers to use their MasterPlatic credit card for purchases rather than a competitive credit card from a different card issuing firm. The net result would be an incremental increase in Share of Wallet for the retailers (2417) and manufacturers (2418) in MasterPlastic's network and thus an increase in the retailers and manufacturers revenues, and an incremental increase in credit card transactions for MasterPlastic, resulting in an increase in MasterPlastic's credit card processing fee revenues.

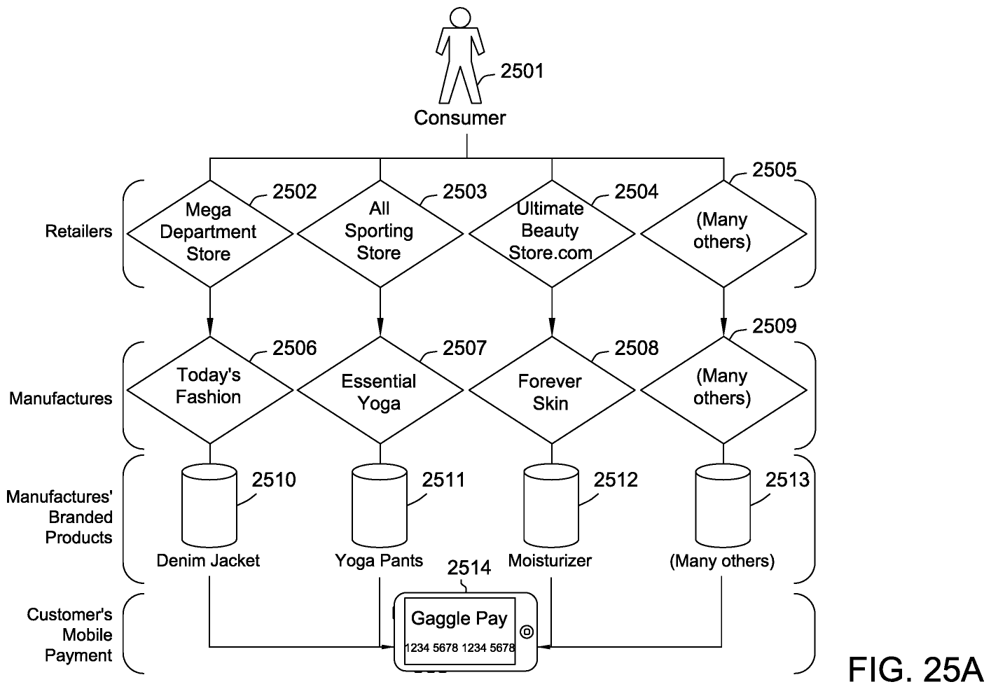

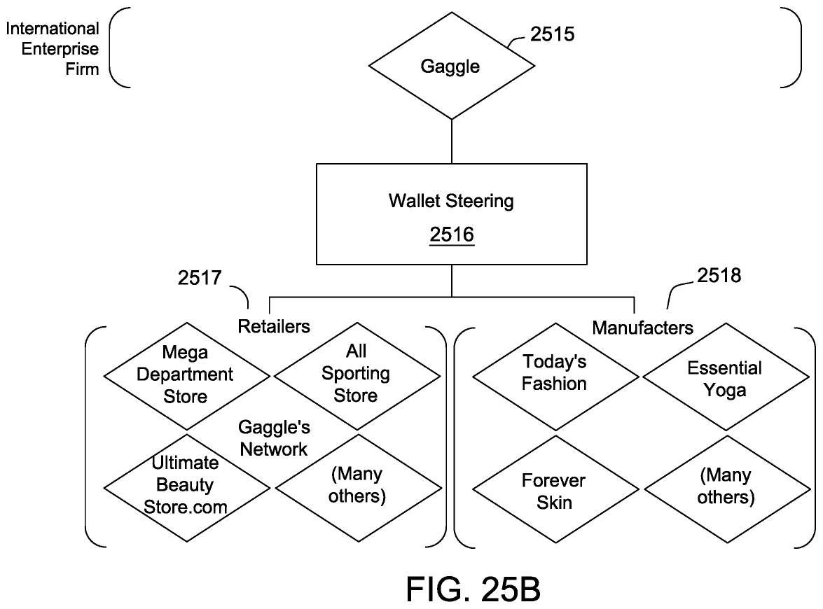

The fictitious global enterprise firm MasterPlastic, an issuer of credit cards to consumers, as illustrated in FIGS. 24A-24B, is one example of an global enterprise firm that could license and use Wallet Steering. A variant of FIGS. 24A-24B is provided in FIGS. 25A-25B, showing how a different fictitious global technology firm, Gaggle (2515), a provider of a wide variety of technologies such as internet search, computer software, mobile phones, a mobile payment service called Gaggle Pay (2514) and many other products and services used daily by tens of millions of consumers, could license and use Wallet Steering. Gaggle Pay, which runs on Gaggle-manufactured mobile phones (2514) is an accepted form of payment at all the physical and E-Commerce retailers (2502 through 2505). A global technology firm such as Gaggle, given its access to and ownership of a huge amount of consumer data spanning internet search, mobile phone usage, payments, and much more, would further amplify the unique power of Wallet Steering by augmenting the Wallet Steering Program member profiles with data which would make Wallet Steering even more precise in its ability to target Wallet Steering Experiences and steer consumer Wallet purchase behavior. Similar to what is illustrated in FIGS. 24A-24B, as shown in FIGS. 25A-25B, imagine Gaggle (2515) has a license to use Wallet Steering (2516). Gaggle would then have access to capabilities for understanding Wallet, Wallet Capacity, Share of Wallet, and Wallet Opportunity data, with an even greater purview compared with an individual retailer or manufacturer, as Gaggle is uniquely positioned in the market to see consumer behavior and transactions spanning many different types of retailers, many different manufacturers, and many different branded products. Gaggle could then offer Wallet Steering capabilities directly to its tens of thousands of retailer customers which accept Gaggle Pay for payment in their stores, to Steer All the Wallets of the many millions of consumers that use Gaggle Pay for payment across the tens of thousands of retailers in Gaggle's network (2517). Further, Gaggle could offer Wallet Steering capabilities directly to the tens of thousands of product manufacturers (2518) for which it has insights into Wallet Capacity and Share of Wallet data for the millions of consumers that use Gaggle Pay for payment across the tens of thousands of retailers in Gaggle Pay's network. If Gaggle had the capability to Steer All the Wallets, it would give Gaggle a significant and unfair advantage over their competitors as it would give retailers in Gaggle's network (2517) a reason to ask consumers to use Gaggle Pay for purchases rather than a competitive digital payments wallet from a different global technology firm. The net result would be an incremental increase in Share of Wallet for the retailers (2517) and manufacturers (2518) in Gaggle's network and thus an increase in the retailers and manufacturers revenues, and an incremental increase in Gaggle Pay transactions for Gaggle, resulting in an increase in Gaggle's processing fee revenues.

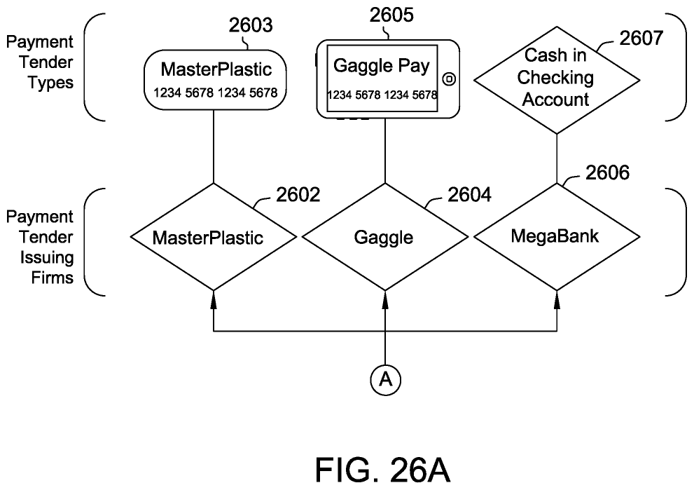

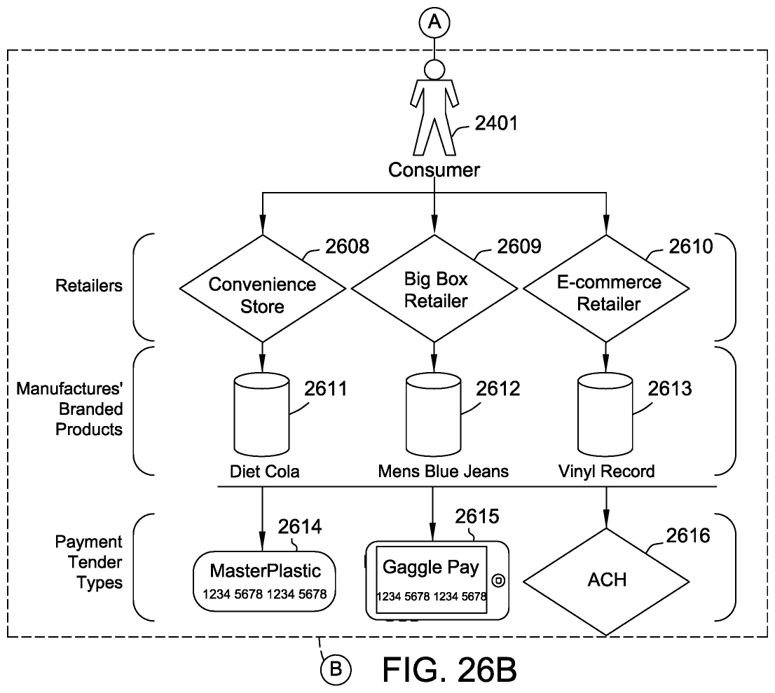

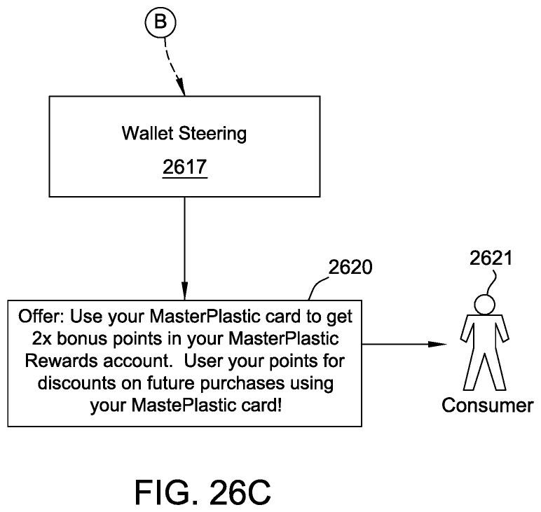

The following description, which for clarity and illustration includes fictitious payment tender issuing firms, fictitious names of payment tender types, and fictitious manufactured branded product names, refers to FIGS. 26A-26C. In this illustrative diagram depicting typical consumer behavior, a consumer (2601) goes to multiple different payment tender issuing firms (2602, 2604 and 2606) for financial services. The consumer obtains a MasterPlastic credit card (2603) from MasterPlastic. The consumer obtains a Gaggle Pay mobile payment account (2605) from Gaggle and also obtains a checking account from MegaBank (2607) where they hold available cash. The consumer, now having access to three different payment tender types (2603, 2605 and 2607) has options for how they pay when they shop. The consumer can pay via their MasterPlastic credit card, via their Gaggle Pay mobile payment account, or using cash when they withdraw money from their checking account at MegaBank. It is important to understand that whenever the consumer makes a payment using any of the non-cash payment tender types (2603 and 2605) the payment tender issuing firms (2602 and 2604) make money. Therefore, it is in the best interest of the payment tender issuing firms to steer a greater share of all the consumer's payments to their payment tender types. For clarity, MasterPlastic wants the consumer to use the MasterPlastic credit card as often as possible for payments, as this increases MasterPlastic's revenue. Gaggle wants the same, for the consumer to use Gaggle Pay as often as possible for payments, thus increasing Gaggle's revenue. Now, imagine the consumer (2601) goes to multiple different retail businesses (2608 through 2610) to make a variety of different types of product purchases and when they do, at each of the retail locations they purchase from, they are a member of each retailer's Wallet Steering Program. At the Convenience Store (2608), the consumer purchases a Diet Cola bottled beverage (2611) using their MasterPlastic credit card (2614). Separately, at the Big Box Retailer (2609), the consumer purchases a pair of Mens Blue Jeans (2612) using their Gaggle Pay account (2615). The consumer also visits an online e-commerce retailer (2610) to purchase a new Vinyl Record from one of their favorite musical groups (2613) using an ACH payment (2616) which withdrawals cash for the payment directly from their MegaBank checking account. The three transaction examples noted immediately above (2608 through 2610) represent only a few examples of what consumers buy and how they pay. The concept applies universally to all products and services a consumer may purchase (2623), from all the different retailers they make those purchases (2622), using all the different payment tender types they choose (2624). Given Wallet Steering creates a comprehensive line-item understanding of the consumer's transaction details, products purchased, quantities, prices, discounts, and so on, this enables the calculation of Share of Wallet and the Wallet Opportunity across all consumers (2601) that shop across all retailers (2622). The typical distribution of payment tender use by the consumer across multiple retailers (2601 through 2615) exists in a many to many relationship wherein the consumer does not always use the same payment tender for the same types of purchases at the same retailers. Wallet Steering (2617) captures all of the Wallet data pertaining to the consumer (2601), captures data on where the consumer shops (2608 through 2610), what they buy, (2611 through 2613), and the specific and different payment tender types the consumer uses (2614 through 2616), all of which is represented by the dotted box (2618). Now, imagine MasterPlastic had access to the Wallet Steering invention, seen and represented by the connection in the dashed line in (2619). MasterPlastic could know that the consumer, when making their bottled beverage Wallet purchases across a variety of retailers, uses their MasterPlastic credit card but also uses Gaggle Pay and cash. MasterPlastic could then, using Wallet Steering, send a targeted Wallet Steering Experience to the consumer (2621) to incentivize the consumer to use their MasterPlastic credit card for all of their purchases (2618), thus influencing the consumer to steer a greater share of their payment tender usage to MasterPlastic. Finally, imagine MasterPlastic applying this payment tender steering capability across all the millions of consumers that carry their cards, across all the retailers the consumers shop, and across all the Wallets the consumer buys. The net outcome for MasterPlastic would be a huge incremental lift in revenues. This power and capability is unique to the Wallet Steering invention.

To further illustrate the capabilities of Wallet Steering, referencing the concepts outlined in the section above and in FIGS. 26A-26C, imagine a major global oil company with drilling, refining, global supply chain, and thousands of retail fuel station locations, fictitiously named SuperOil, had a partnership with MasterPlastic. In this partnership, SuperOil created a private label credit card (powered by MasterPlastic) to offer to the consumers that purchase SuperOil fuel for their vehicles from SuperOil retail fueling sites. In this scenario, SuperOil will have cost advantages for payment processing when its consumers sign up for its private label SuperOil credit card, as its processing fees for card carrying members (consumers) will be lower compared with other forms of card-based payments. Now, imagine SuperOil also had access to Wallet Steering and as described in the section above, could use these capabilities to execute payment tender steering for the purposes of getting more of their consumers to become SuperOil private label credit card carrying members and to steer a greater percent of their consumers' purchases from other types of card payments to using the SuperOil private label credit card. This outcome, if scaled across SuperOil's thousands of fuel retail locations and millions of consumers, would result in huge payment processing fee savings for SuperOil.

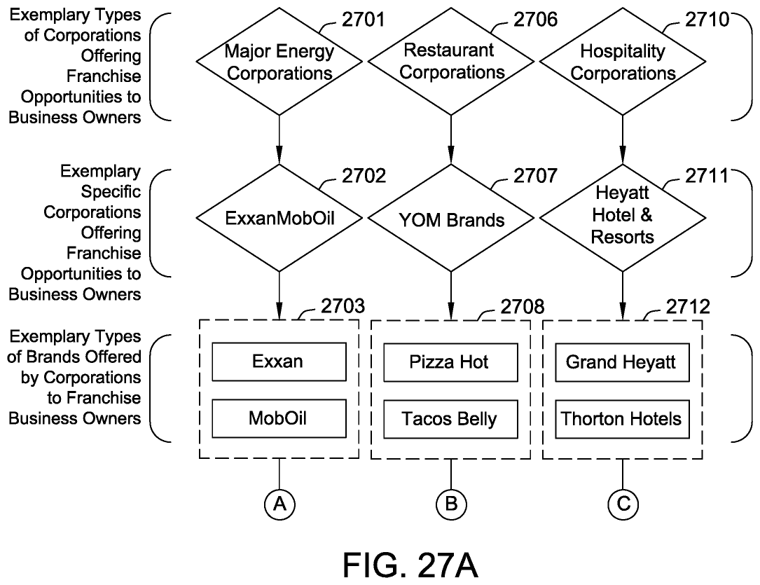

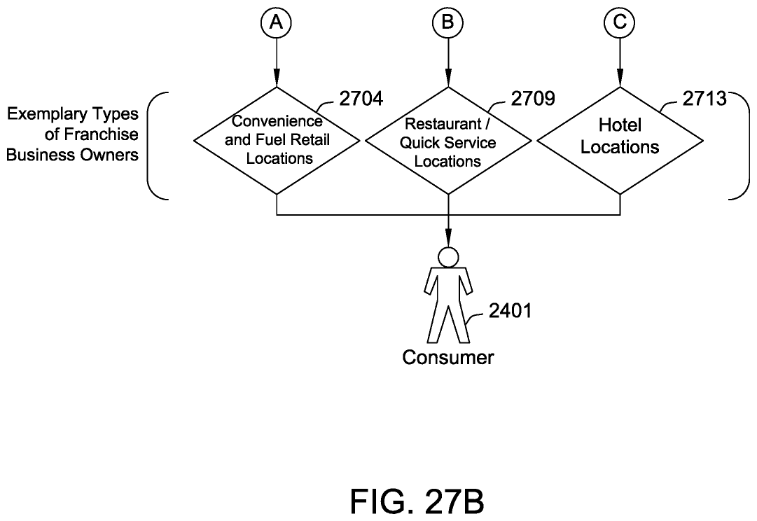

Wallet Steering includes a capability referred to as Retailer Connect, a corporate-to-franchise connectivity engine aligning corporations offering franchise opportunities and franchise business owners on performance toward mutual business outcomes. Before outlining how Retailer Connect works, it is important to understand the nature of the relationship between a corporate franchisor and a business franchise owner. There are multiple types of corporate-to-franchise business relationships as illustrated in FIGS. 27A-27B, using fictitious corporation and brand names. For example, a Major Energy Corporation (2701) such as ExxanMobOil (2702) offers multiple different fuel brands, including Exxan and MobOil (2703), which business owners that run Convenience and Fuel Retail locations (2704) may license to, for example, sell Exxan-branded fuel at the fueling stations outside their convenience store directly to consumers (2705). A Restaurant Corporation (2706) such as YOM Brands (2707) offers multiple different restaurant or quick service brands, including Pizza Hot and Tacos Belly (2708), which business owners that run Restaurant/Quick Service locations (2709) may license to, for example, sell Pizza Hot pizza at their locations directly to consumers (2705). A Hospitality Corporation (2710) such as Heyatt Hotels & Resorts (2711) offers multiple different hotel or resort brands, including Grand Heyatt and Thorton Hotels (2712), which business owners that run Hotel locations (2713) may license to, for example, open a Grand Heyatt hotel and offer hospitality services directly to consumers (2705). In these exemplary business relationships between the corporations offering the franchise opportunities and the business owners which are the licensees of the franchise brands, both the corporation and the business owner have mutually aligned objectives of executing Wallet Steering to acquire and retain a greater Share of consumer's Wallets. The Retailer Connect corporate-to-franchise connectivity engine enables corporate to hold franchise operators accountable to Wallet Steering Program performance (such at the number of members to join the program in a month and the number of transactions from members in a month, for the franchise operators specific retail sites), enables franchise operators to hyper-personalize the consumer experience to their business locations (for the purpose of Wallet Steering), enables franchisees and corporations to view and optimize store performance and configure program rules via a mobile and web-based interface, to deliver mutual benefits and transparency for the achievement of greater program performance and increased business outcomes.

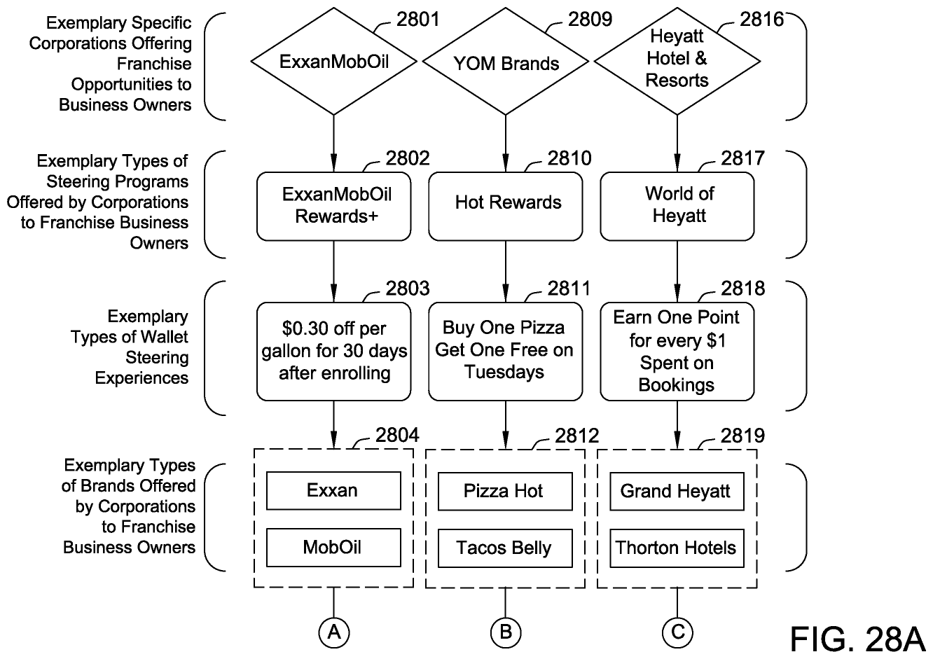

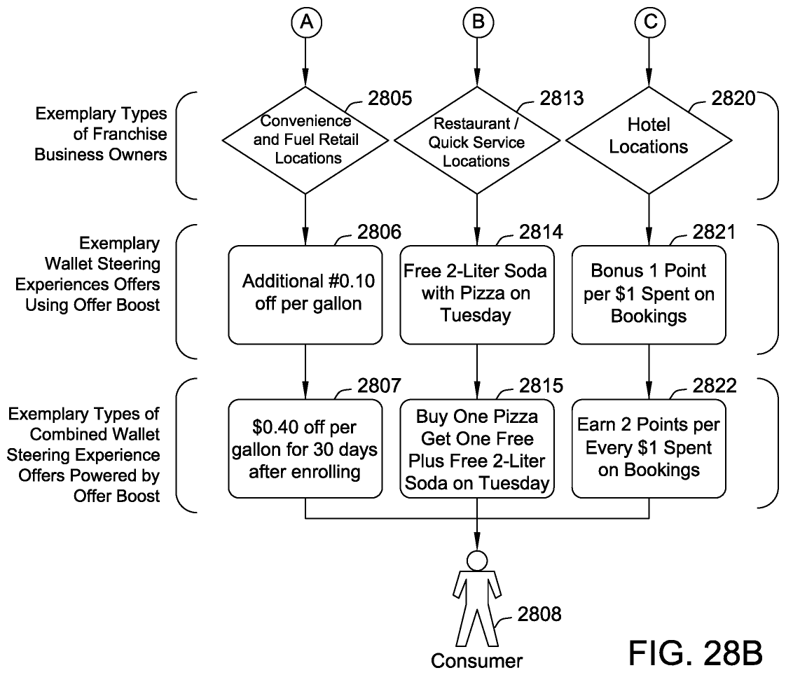

There are many ways Retailer Connect may be used together by corporations and franchise business owners. To illustrate, a few examples are provided in FIGS. 28A-28B, using fictitious corporation and brand names. A Major Energy Corporation such as ExxanMobOil (2801), seeking to increase the amount of Exxan-branded fuel (2804) sold by franchise business owners at their locations (2805) may set a performance goal for the business owners operating fueling locations to get more consumers (2808) to enroll as members in the corporate-sponsored Exxan MobOil Rewards+ program (2802). The performance goal would be configured in Retailer Connect's mobile and web-based interface and would enable tracking of progress against said goal, to both ExxanMobOil and the franchise business owners that sell Exxan fuel to consumers. In order for ExxanMobOil to help business owners increase the number of enrolled members in its program, the corporation may sponsor a limited time discounted fuel offer, exclusive to members (2803) and make that offer available to all franchise business owners who have opted in to participate in the corporate-sponsored program. Retailer Connect also includes a capability called Offer Boost. Offer Boost enables the franchise business owner(s) to add an additional incentive on top of the corporate sponsored offer (2806), and combine the two (2803 and 2806) into a more attractive offer for the consumer (2807). A corporate sponsored offer could take multiple forms. For example, one corporate sponsored offer could be an evergreen offer, such as a discount or promotion that is ‘always on’ and available to the franchise business and its consumers. Another type of corporate sponsored offer could be a temporary discount or promotion that is only available for a certain period of time, or at certain locations. Similarly, YOM Brands' (2809) Hot Rewards program (2810) may sponsor a pizza offer (2811) and make this offer available through participating franchise business owners (2813) that operate Pizza Hot (2812) stores. The business owners may choose to use Offer Boost to add further incentive to the YOM Brands' pizza offer (2814), resulting in a combined offer (2815) that is more attractive to the end consumer. A similar example for Retailer Connect and Offer Boost is provided in FIGS. 28A-28B for Heyatt Hotels & Resorts (2816-2822).

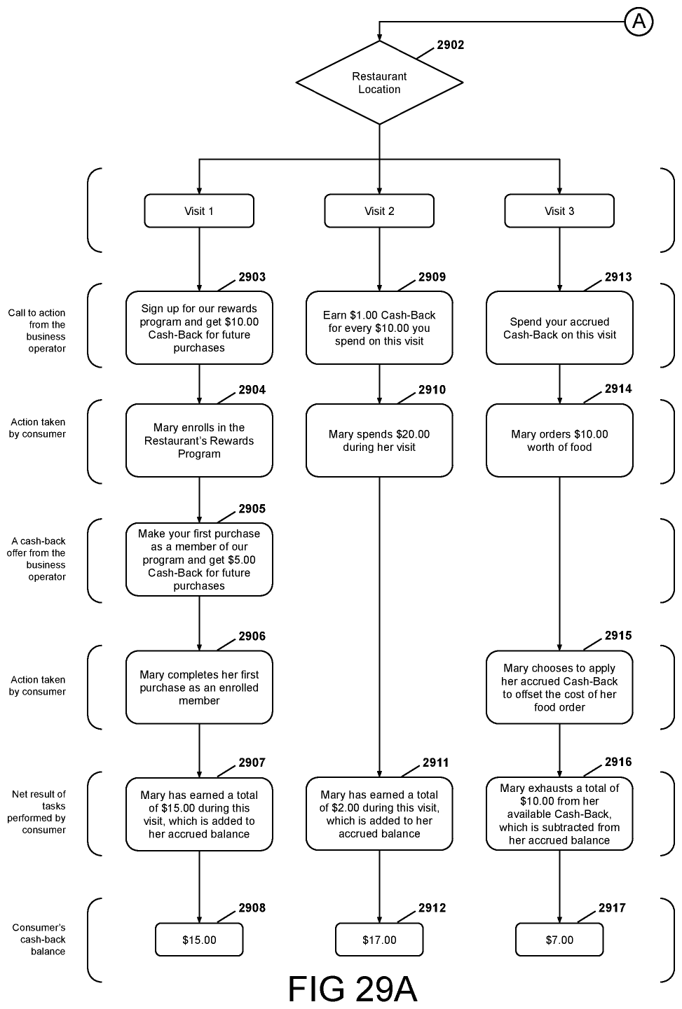

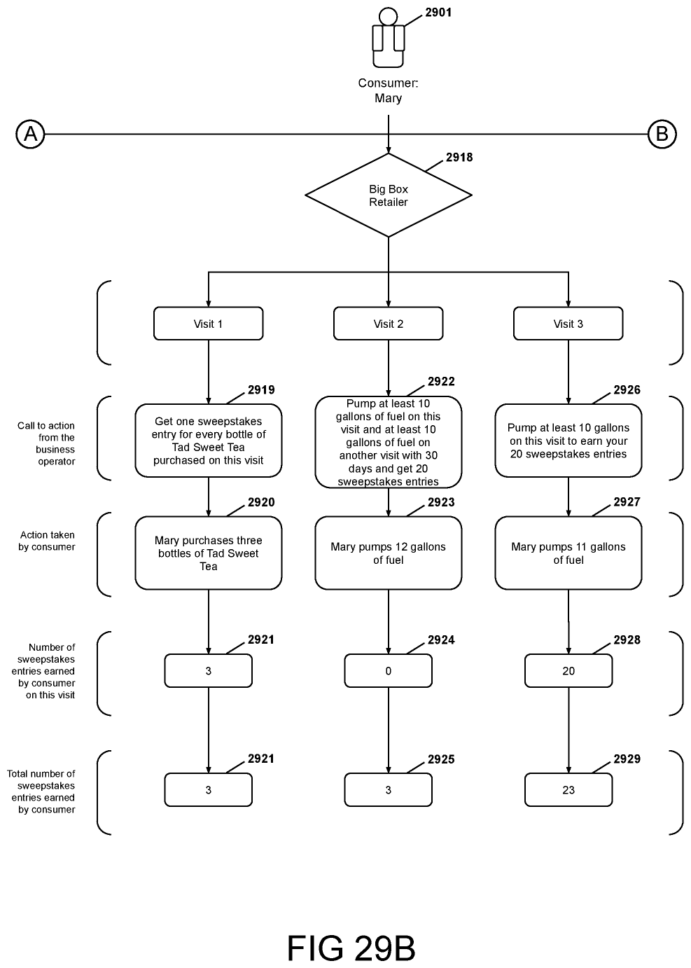

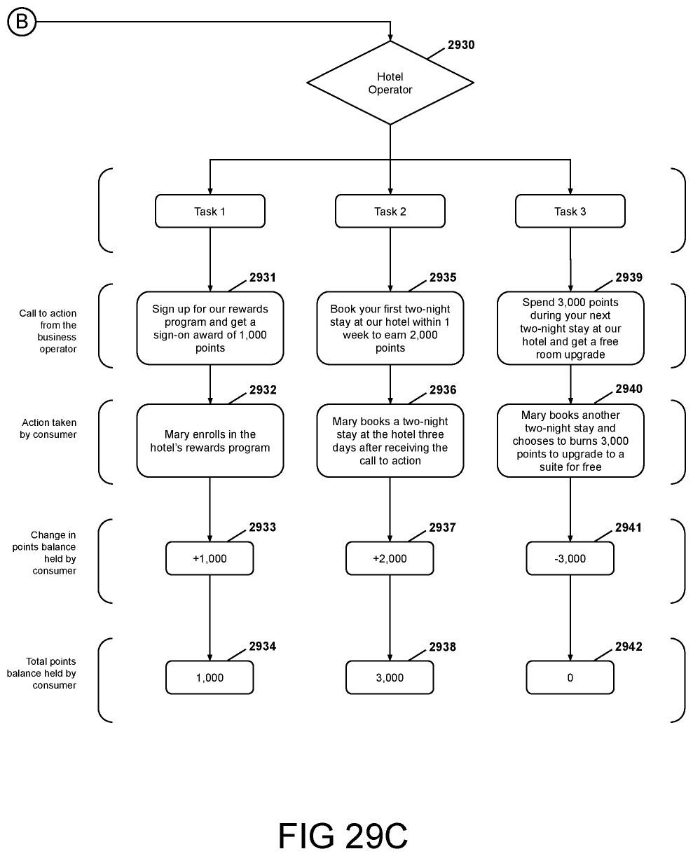

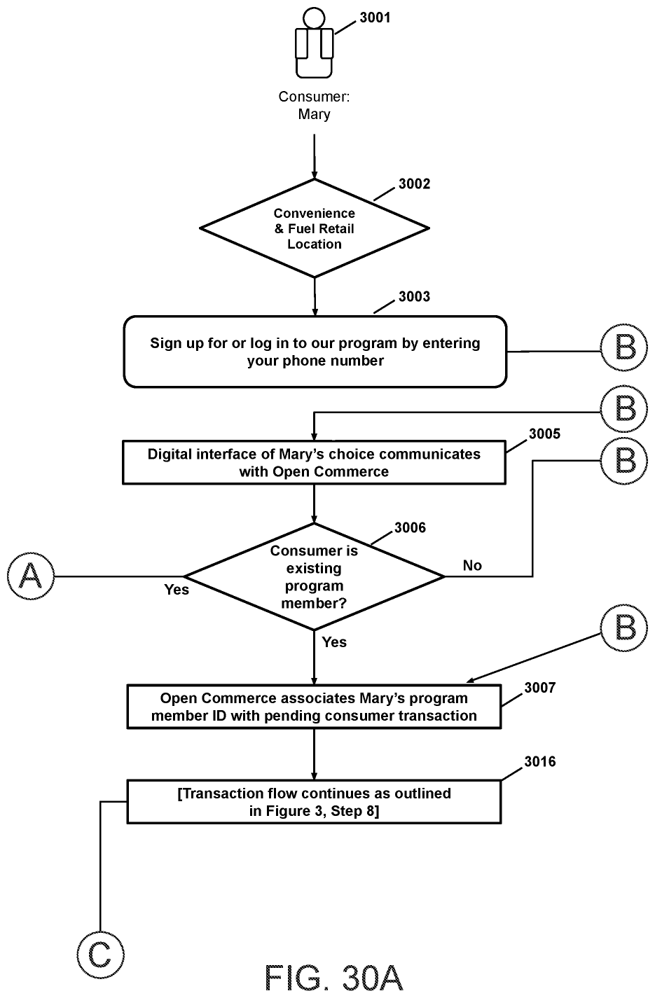

Wallet Steering empowers businesses to leverage a variety of Wallet Steering Experiences which may utilize various Wallet Steering Currencies. To illustrate, examples are provided in FIGS. 29A-29C. One specific type of Wallet Steering Experience is called cash-back, which uses a cash-value based Wallet Steering Currency. Cash-back enables businesses to offer consumers the ability to complete a task to earn cash-back, purchase any number of different types of products and services and earn cash-back from those purchases, and/or use accrued cash-back in the consumer's membership account to offset the cost of future purchases. In this example, a fictitious consumer named Mary (2901) completes three different tasks on three different visits to a restaurant location (2902). During visit number one, Mary is prompted to enroll in the retailer's Wallet Steering Program and by doing so, Mary will earn $10.00 cash-back toward future purchases (2903). Mary chooses to enroll (2904) and during her visit, also receives an offer to make her first purchase as a new member to receive additional cash-back (2905). Mary completes her first purchase (2906) and earns a total of $15.00 cash-back from her first visit (2907) which is added to Mary's accrued cash-back balance (2908). During visit number two, Mary is prompted to earn $1.00 cash-back for every $10.00 she spends during that visit (2909) and as Mary spends $20.00 during that visit (2910), she earns $2.00 (2911) which is added to her cash-back balance (2912). On Mary's third visit, she is prompted with an offer to spend her accrued cash-back during her visit (2913). Mary orders $10.00 worth of food (2914) and chooses to apply accrued cash-back from her available balance to offset the cost of her food order (2915). Mary exhausts $10.00 from her balance (2916), resulting in a new available cash-back balance of $7.00 (2917). In this example, the business has a license to Wallet Steering and is running a Wallet Steering Program. The business is using Wallet Surveys to identify Mary's Wallet Capacity, is automatically tracking and calculating their share of Mary's dining-out purchases, and then automatically directing specific Wallet Steering Experiences to Mary to earn a greater share of Mary's dining-out purchases, leading to a more profitable relationship with Mary.

As provided in FIGS. 29A-29C, another specific type of Wallet Steering Experience is called a Sweepstakes. Sweepstakes enable businesses to offer consumers the ability to enter for a chance to win something of value. In this example, a fictitious consumer named Mary completes a series of three different tasks on three different visits to a Big Box retail business operator (2918). During Mary's first in a series of three visits, she receives a call to action to purchase a specific type of product to earn an entry in a sweepstakes (2919). Mary purchases three qualifying products (2920) and earns three sweepstakes entries (2921), bringing her total cumulative number of sweepstakes entries up from zero to three (2922). On Mary's second visit, she receives a call to action to pump a certain number of gallons of fuel on that visit and a certain number on a following visit to earn 20 sweepstakes entries (2922). Mary pumps the number of gallons of fuel during the visit, meeting the criteria for her first fill up (2923), however Mary needs to complete one more visit for fuel in order to earn her 20 sweepstakes entries, and therefore does not earn any additional sweepstakes entries on her second visit (2924). On Mary's third visit, she receives a call to action to pump a certain number of gallons to earn her 20 sweepstakes entries (2926). Mary pumps the number of gallons of fuel during the visit (2927), meeting the criteria and earning her 20 sweepstakes entries (2928) and bringing her cumulative total number of sweepstakes entries to 23 (2929). In this example, the Big Box retail business has a license to Wallet Steering and is running a Wallet Steering Program. The business is using Wallet Surveys to identify Mary's Wallet Capacity, is automatically tracking and calculating their share of Mary's bottled beverage and fuel purchases, and then automatically directing specific Wallet Steering Experiences to Mary to earn a greater share of Mary's bottled beverage and fuel purchases, leading to a more profitable relationship with Mary.

As provided in FIGS. 29A-29C, another specific type of Wallet Steering Currency is called points, which may be used in combination with a variety of different types of Wallet Steering Experiences. Using points as a Wallet Steering Currency enables businesses to ask consumers to complete a task to earn points, enable consumers to accrue points over time, grant points directly to a consumer at the discretion of the business, expire points accumulated by a consumer at the discretion of the business, and/or enable consumers to burn/spend points to redeem something else of value. In this example, a fictitious consumer named Mary (2901) completes three different tasks with a hotel operator (2930). During Mary's first visit to the hotel operator where she will be staying for a few nights, she is prompted to enroll in the hotel operator's Wallet Steering Program and by doing so, Mary will earn 1,000 points (2931). Mary chooses to enroll (2932) while she is checking in at the hotel and earns 1,000 points (2933) which is added to Mary's accrued points balance (2934). After Mary completes her first stay at the hotel, Mary is prompted to book another stay with the hotel operator to earn 2,000 points (2935). Mary completes the booking (2936) and earns 2,000 points (2937), bringing her total accumulated points balance to 3,000 (2938). Following her next stay at the hotel, Mary is prompted to spend some of her points to receive a free room upgrade (2939). Mary decides to book another stay at the hotel and during the booking process, she chooses to burn 3,000 points in order to upgrade from a standard room to a suite for free (2940). This points-burn effectively removes 3,000 points from Mary's points balance (2941), leaving Mary with a net total points balance of zero (2942). In this example, the business has a license to Wallet Steering and is running a Wallet Steering Program. The business is using Wallet Surveys to identify Mary's Wallet Capacity, is automatically tracking and calculating their share of Mary's hotel booking purchases, and then automatically directing specific Wallet Steering Experiences to Mary to earn a greater share of Mary's hotel booking purchases, leading to a more profitable relationship with Mary.

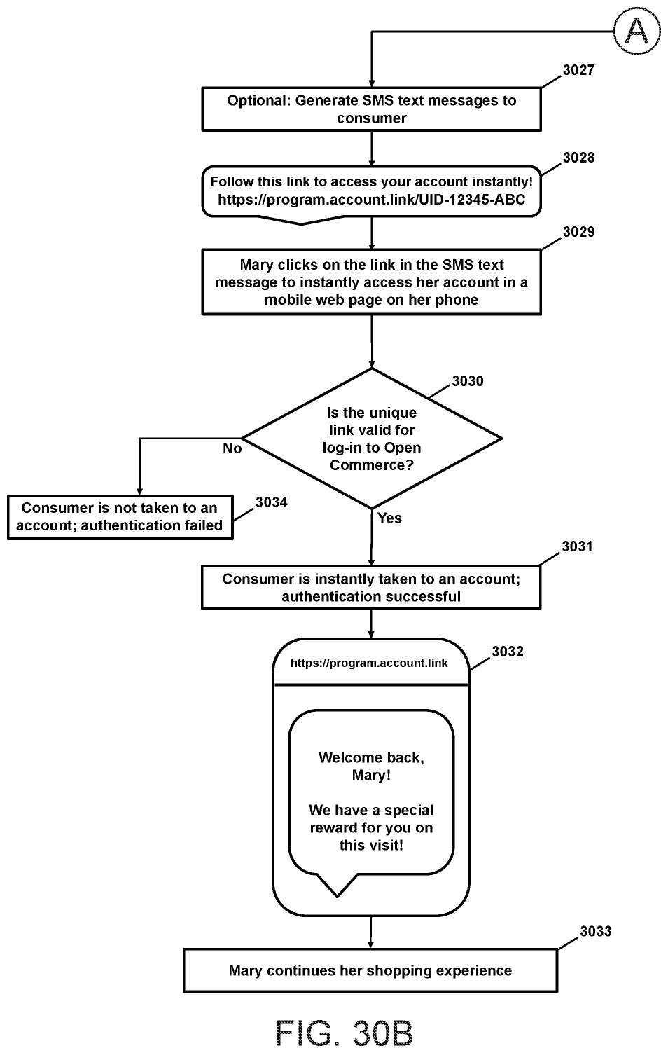

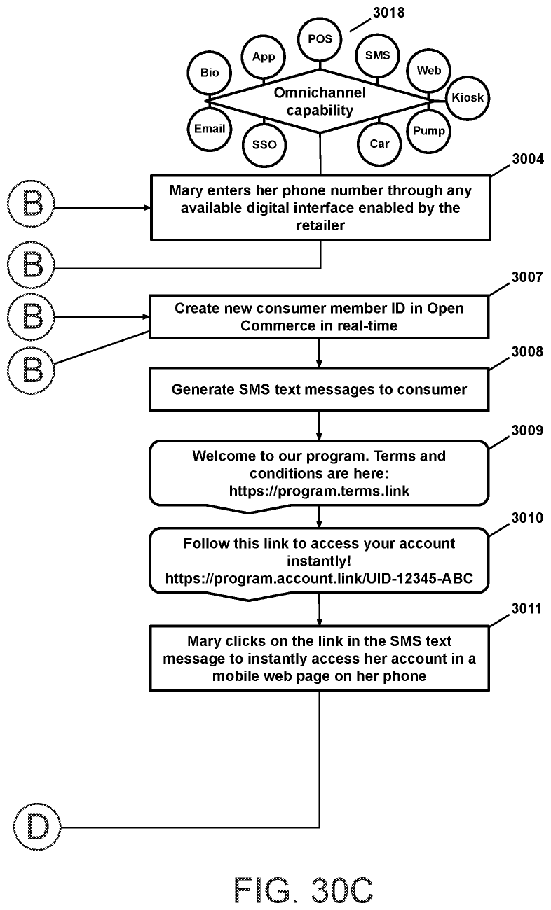

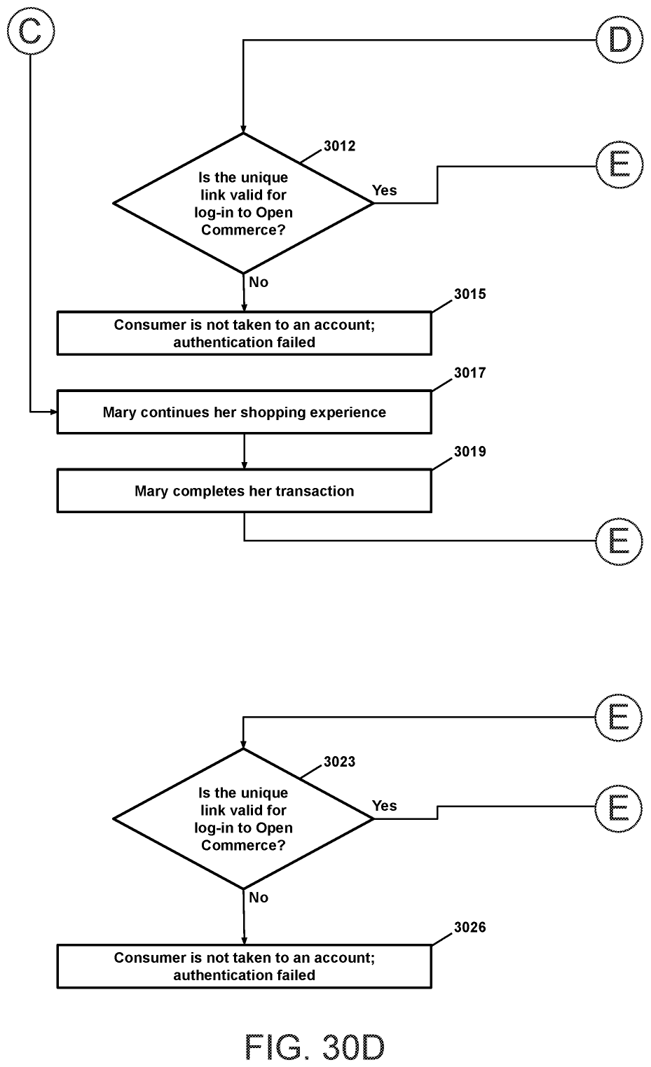

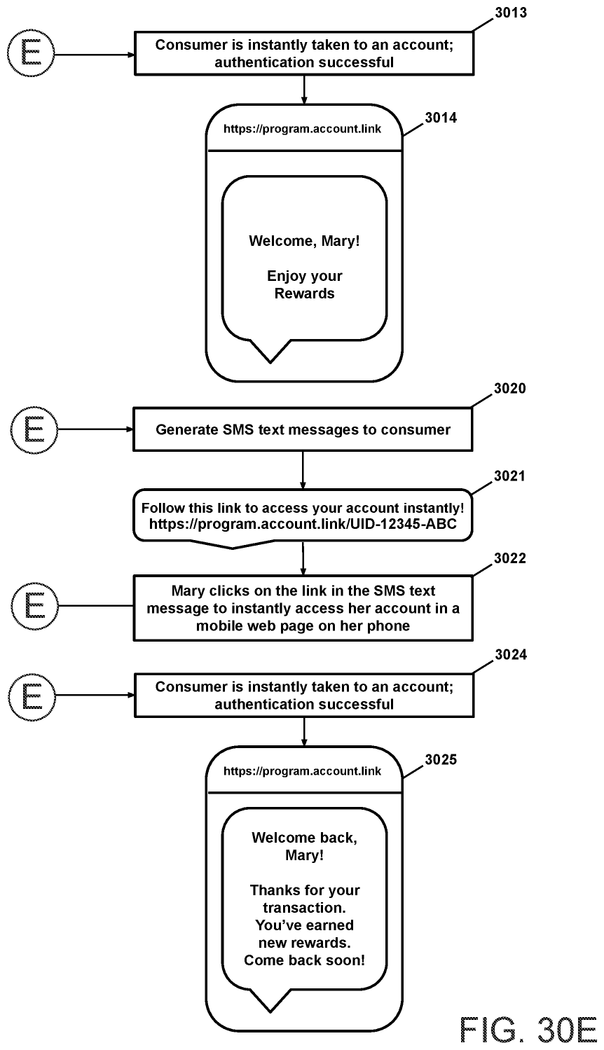

Wallet Steering Program Enrollment and Identification enables a particular business running a Wallet Steering Program to enable consumers to enroll as members in the particular business's program and to self-identify for ongoing participation in the particular business's program via use of different technologies, including but not limited to InstantJoin™ (a technology offered by Stuzo), SMS text messages, website links, websites, mobile applications, push messages, various forms of biometrics, including technologies such as fingerprint recognition, facial recognition, or retinal recognition, point of sale systems, fuel dispenser systems, kiosks, connected car infotainment systems, email messages, or single-sign-on features offered by various 3rd party technology companies, such as social media platforms. To illustrate, process flows are provided in FIGS. 30A-30E. In the provided examples, a fictitious consumer named Mary (3001) visits a Convenience & Fuel Retail location (3002), which is operated by a business that has a license to use Wallet Steering and Stuzo's Open Commerce product suite. This Convenience & Fuel Retail business is operating a Wallet Steering Program, its primary means of employing Wallet Steering. When Mary visits the location, she sees signage asking her to sign up for or log in to the retailer's program by entering just her phone number (3003). Mary has a variety of choices for how and where she can enroll into engage with the retailer's program using her phone number, including a native mobile application (iOS, Android), at the pin pad on the retailer's point of sale (POS) system, directly via SMS text message, via a mobile website, via a biometric authentication from a device (such as a mobile phone, using fingerprint biometrics or facial recognition biometrics), via a kiosk at the retailer's location, via the pin pad on the retailer's fuel dispenser (where Mary would purchase fuel for her car), on the infotainment screen inside her internet-enabled car, via a single sign-on (SSO) through connections with other 3rd party platforms (such as social media platforms), and more (3018). Mary enters her phone number at the pin pad on the retailer's POS system to participate in the retailer's program (3004). The POS system then communicates with Open Commerce (3005) to check if Mary is already a member of the retailer's program (3006). At this point in the process flow, Mary's journey differs based on whether she is already a program member or not. Illustrations of both flows are provided, starting first with a flow where Mary is not yet a program member, then following with a flow where Mary is already a program member. First, in the flow where Mary is not a member, Open Commerce creates a new membership profile for Mary in Open Commerce in real-time (3007). Open Commerce then generates a series of SMS text messages to Mary (3008), to the phone number Mary typed in at the pin pad on the POS system. The first SMS text message welcomes Mary to the program and provides a hyperlink which Mary can click on to view the terms and conditions of the retailer's program (3009). The second SMS text message includes a magic link (a hyperlink) which Mary can click to instantaneously authenticate into her account and access her account information (3010). Mary clicks on the hyperlink in the SMS text message to instantly access her account in a mobile web page on her phone (3011), which opens up a mobile web page in a web browser on her mobile phone. The web browser reads the hyperlink and communicates with Open Commerce to check if the unique code found inside the hyperlink matches with the temporary unique code stored in Open Commerce for Mary, generated specifically for a unique session for Mary (3012). If the code does not match, the flow stops due to an authentication failure (3015). When the code does match, Mary is instantaneously authenticated into her account and presented with a unique message and digital experience inside a mobile web page (3014). Mary then continues with her transaction at the Convenience & Fuel Retail location (3016), continues her shopping experience (3017) and completes her transaction (3019) by purchasing the items she selected during her visit to the retailer's store. Upon completion of Mary's transaction, the retailer's POS system communicates with Open Commerce, telling Open Commerce that the transaction is finalized and providing granular details on Mary's transaction, which are then stored in Mary's member profile in Open Commerce. Open Commerce then immediately generates a new SMS text message to Mary (3020) with a new magic link (hyperlink) for Mary to access her account for updates from her transaction (3021). Mary clicks on this hyperlink (3022) and again Open Commerce runs the logic to determine if Mary should be authenticated or not (3023) and when successfully authenticated, Mary is taken directly into a mobile web page in a web browser on her phone where she can see new information about her member account (3025). This concludes the process flow where Mary was not yet a member. An additional process flow is illustrated wherein Mary, upon entering her phone number (3004) is identified by Open Commerce as already being a member of the retailer's program (3006). Open Commerce has the capability of enabling the retailer to optionally trigger a message to an existing program member, in real-time, at the beginning of their transaction, immediately upon entering their phone number (3027). In this example, Mary receives an SMS text message with a magic link (hyperlink) (3028). Mary clicks on the hyperlink in the SMS text message to instantly access her account in a mobile web page on her phone (3029), which opens up a mobile web page in a web browser on her mobile phone. Again, Open Commerce runs the logic to determine if Mary should be authenticated or not (3030) and when successfully authenticated (3031), Mary is taken directly into a mobile web page in a web browser on her phone where she can see new information in her member account that is personalized to Mary and relevant to that specific visit at the Convenience & Fuel Retail location (3032). Mary then continues her shopping experience (3033), taking advantage of a personalized Wallet Steering Experience that was provided by the retailer to Mary, which effectively steered a greater Share of Mary's Wallet to that retailer on that visit.

An additional unique invention and capability of Wallet Steering, powered by Open Commerce, is the ability to dynamically calculate and send a consumer an SMS text message post-transaction, showing the consumer the precise amount of savings they realized per item purchased within a transaction where the consumer applied available cash-back from their member account to the transaction. Cash-back is a type of Wallet Steering Currency as detailed in section [0070] above. To explain, we'll provide a couple examples, one with a fuel transaction and one with a bottled beverage transaction. For the first example, imagine a fictitious consumer named Mary visits a convenience store where she is a member of that store's rewards program (which is using Wallet Steering, powered by Stuzo's Stuzo's Open Commerce product suite). In Mary's rewards program member profile, Mary has an available cash-back balance of $10.00, which she may apply to any qualifying purchase at the store. Qualifying purchases include items such as gallons of fuel, coffee, sandwiches, and other products. During this visit, Mary decides to apply $5.00 of her cash-back balance to a fuel transaction and selects this option in the convenience store's rewards program mobile app prior to initiating the fuel transaction at the pump. Mary then enters her phone number at the pump to self-identify as a member of the convenience store's rewards program and proceeds to fill up her gas tank by pumping 10 gallons of fuel. After Mary places the fuel dispenser nozzle back in its holder to complete her transaction, within moments, Mary receives an SMS text message from the convenience store's rewards program, telling Mary that she just saved $0.50 per gallon during her visit. The above capability is novel as with other rewards programs offered by convenience and fuel retailers, the retailer may (A) offer all consumers the same cents-off-per-gallon discount for joining their rewards program (example: “Save $0.10/gallon when you sign up), (B) offer all newly enrolled consumers the same cents-off-per-gallon discount for joining their rewards program, for a limited period of time after joining the program (example: “Save $0.15/gallon for the first 30 days after signing up), and/or (C) not give the consumer any choice in applying a particular currency (such as points or cash-back) at the amount the consumer desires toward a specific transaction and a specific product at a time the consumer selects (example: if Mary has a $10.00 cash-back balance in her member profile and wishes to purchase 3 gallons of regular grade fuel, which costs $3.33/gallon, Mary's transaction total would be $10.00 and she could select to use her entire cash-back balance to offset the entire cost of her transaction, however retailers today are incapable of supporting this rewards mechanic for Mary). For the second example, imagine a fictitious consumer named Derek visits a grocery store where he is a member of that store's rewards program (again using Wallet Steering, powered by Stuzo's Stuzo's Open Commerce product suite). In Derek's rewards program member profile, Derek has an available cash-back balance of $25.00, which he may apply to any qualifying purchase at the store. Qualifying purchases include items such as baked goods, consumer packaged goods, fresh prepared meals, bottled beverages, and more. During this visit, Derek decides to apply $3.00 of his cash-back balance to a bottled beverage transaction and selects this option in the grocery store's rewards program mobile app prior to initiating the transaction at the checkout. Derek then proceeds to grab four bottles of electrolyte sports beverage and proceed to the checkout. At the checkout, Derek enters his phone number at the pin pad attached to the point of sale system to self identify as a member of the grocery store's rewards program, has the cashier ring up his bottles of sports beverage, and pays for his transaction. Within moments following the transaction, Derek receives an SMS text message from the grocery store's rewards program, telling Derek he just saved $0.75 per bottled beverage he purchased during his visit. The above capability is novel as with other rewards programs offered by grocery stores, the retailer may (A) offer all consumers the same discount per product (example: “Rewards members save $0.20 per bottle of electrolyte sports beverage), (B) offer all consumers the same discount per product with a limit (example: “Rewards members save $0.50 per bottle of electrolyte sports beverage up to but not to exceed two bottles), and/or (C) does not give the consumer any choice in applying a particular currency (such as points or cash-back) at the amount the consumer desires toward a specific transaction and a specific product at a time the consumer selects (example: if Derek has a $25.00 cash-back balance in his member profile and wishes to purchase 10 bottles of electrolyte sports beverage, which costs $2.50 per bottle, Derek's transaction total would be $25.00 and he could select to use his entire cash-back balance to offset the entire cost of his transaction, however retailers today are incapable of supporting this rewards mechanic for Derek). The above two examples (Mary at the convenience store and Derek at the grocery story) are uniquely enabled for a business operator using Wallet Steering for delivering a hyper-personalized experience for their program members, giving those program members more choice and flexibility in how they apply earned Wallet Steering Currencies to the transactions they desire, for the products they want, at the time they prefer and to receive real-time communications via SMS text message regarding exactly how much they saved per item purchased, just moments after a successful transaction. This novel approach, empowered by Wallet Steering, leads to consumers having a better experience with a business' program, shopping with that business more frequently, purchasing more from a business, and becoming more valuable to a business.

We claim:

1. A computer-implemented method associated with a wallet steering program, the method comprising:
receiving, during a transaction, a consumer identifier;
in response to receiving the consumer identifier, automatically creating a consumer member profile for the consumer identifier;
storing at least one data element associated with at least one transaction and the consumer in the consumer member profile;
generating at least one offer based on the consumer member profile; and
transmitting, to a remote computing device, at least one communication to the consumer, the at least one communication including an offer for at least one good or service related to the transaction.

2. The computer-implemented method of claim 1, further comprising, in response to receiving the consumer identifier in at least one subsequent transaction, storing at least one data element associated with the at least one subsequent transaction to the consumer member profile.

3. The computer-implemented method of claim 1, wherein the at least one communication comprises at least one first communication including an offer, and further comprising transmitting, to the consumer, at least one second communication including a request.

4. The computer-implemented method of claim 3, further comprising, in response to the request being fulfilled, transmitting, to the consumer, at least one third communication including an offer.

5. The computer-implemented method of claim 3, wherein the request for the consumer comprises authenticating the consumer member profile, downloading an application, inputting additional personal information, or responding to a wallet survey.

6. The computer-implemented method of claim 1, wherein the at least one data element is associated with at least one of personal information of the consumer, a location of the consumer, a location of the transaction, at least one of a data or time associated with the transaction, or a cost associated with a good or service purchased in the transaction.

7. The computer-implemented method of claim 1, wherein the at least one communication includes a hyperlink which directs the consumer to the at least one offer.

8. A computer-implemented method associated with a wallet steering program, the method comprising:
receiving into a digital wallet at least one attribute of each of a plurality of consumer-initiated transactions;
generating, based on the at least one attribute a wallet capacity associated with at least one good or service;
transmitting, to a consumer via a computing device, a wallet survey associated with the least one good or service;
receiving, from the computing device, a consumer response to the at least one wallet survey; and
determining, based on the consumer response to the at least one wallet survey, a wallet opportunity of the at least one good or service for the consumer.

9. The computer-implemented method of claim 8, further comprising storing the wallet opportunity of the at least one good or service for the consumer in a consumer member profile.

10. The computer-implemented method of claim 8, wherein the wallet opportunity is based at least in part on a wallet capacity of the at least one good or service for the consumer.

11. The computer-implemented method of claim 10, further comprising receiving, from a third-party database, third party data associated with a consumer identifier, and wherein the wallet capacity is based at least in part on the third-party data.

12. The computer-implemented method of claim 8, further comprising generating at least one assumption based on the consumer response, and wherein the wallet opportunity is based at least in part on the at least one assumption.

13. A computer-implemented method associated with a wallet steering program, the method comprising:
receiving a first offer for at least one good or service, the first offer being corporate-sponsored offer;
receiving a second offer for the at least one good or service, the second offer being a merchant sponsored offer; and
combining the first offer and the second offer to generate a third offer.

14. The computer-implemented method of claim 13, wherein the first offer is an evergreen offer that is always available to at least one of merchants or consumers.

15. The computer-implemented method of claim 13, wherein the first offer has time or location constraints.

16. The computer-implemented method of claim 13, wherein the first offer and the second offer are combined in response to an input by a merchant selling the at least one good or service.

17. A computer-implemented method associated with a wallet steering program, the method comprising:
receiving, during a transaction, a consumer identifier;
identifying a consumer member profile using the consumer identifier;
transmitting, to a first merchant-controlled device, a first offer in response to the transaction for a first good or service; and
transmitting, to a second merchant-controlled device, a second offer in response to a redeeming of the first offer.

18. The computer-implemented method of claim 17, wherein the first merchant-controlled device is distinct from the second merchant-controlled device.

19. The computer-implemented method of claim 17, wherein the first merchant-controlled device is a fuel dispenser.

20. The computer-implemented method of claim 17, wherein the merchant computing device is a merchant point of sale device or an ordering device.
